(19) United States
(12) Patent Application Publication
(10) Pub. No.: US 2020/0009725 A1
(43) Pub. Date: Jan. 9, 2020

(54) HOLDING DEVICE FOR FOOD

(71) Applicant: KAWASAKI JUKOGYO KABUSHIKI KAISHA, Kobe-shi, Hyogo (JP)

(72) Inventors: Yasuhiko HASHIMOTO, Kobe-shi (JP); Kenji BANDO, Nishinomiya-shi (JP); Kazunori HIRATA, Yao-shi (JP); Keita SASAKI, Akashi-shi (JP)

(73) Assignee: KAWASAKI JUKOGYO KABUSHIKI KAISHA, Kobe-shi, Hyogo (JP)

(21) Appl. No.: 16/468,021

(22) PCT Filed: Dec. 7, 2017
(86) PCT No.: PCT/JP2017/043913

§ 371 Date: Jun. 10, 2019

(30) Foreign Application Priority Data
Dec. 9, 2016 (JP) 2016-238983
Jun. 12, 2017 (JP) 2017-115489

(51) Int. Cl. B25J 9/16; B25J 15/06; B25J 19/02; B25J 11/00; B25J 15/08; B65B 35/18; B65B 35/38; B65B 57/10

(52) U.S. Cl. CPC B25J 9/1612; B25J 15/0616; B25J 19/021; B25J 11/0045; B65B 57/10; B25J 15/08; B65B 35/18; B65B 35/38; B25J 9/1697

(57) ABSTRACT

A holding device for food includes a second posture detecting part configured to detect that all the plurality of foods fed to the given positions are in the second posture, and a control part configured to control operation of the second holding part to hold the plurality of foods in the second posture so that the foods are piled up in the given direction, when the second posture detecting part detects that all the plurality of foods are in the second posture at the given positions.

### TECHNICAL FIELD

The present disclosure relates to a holding device for food.

### BACKGROUND ART

Generally, in a production line for food, such as rice balls and sandwiches, the produced foods are packed into a container and shipped to retail stores, such as convenience stores. Therefore, in terms of transportation cost etc., the foods are desirably packed into the container with high accommodation efficiency. However, the packing work is difficult to be automated, and depends on human labor. Such a food is easy to be deformed, and once it is deformed by an external force, it will not resume its original shape even if the external force is removed. Therefore, if the food falls and is deformed by the external force, the commodity value of the food is spoiled by the deformation. As a result, a ratio of nonconforming products increases to deteriorate the work efficiency.

Conventionally, there are devices which can hold a plurality of food. For example, a boxing device disclosed in Patent Document 1 sucks and holds foods (cucumbers) of a front row and a rear row placed in two respective alignment trays by respective suction pads, and supports each food (cucumber) in a posture where a rear end part of the food is slightly inclined downwardly. Then, the front-row food (cucumber) and the rear-row food (cucumber) sucked and held by the suction pads are overlapped at their longitudinal ends, and are then boxed. Moreover, a boxing device disclosed in Patent Document 2 lifts a plurality of foods (rice balls) upward via a suction unit in a suspending manner, the suspended foods are moved to a given boxing position and lowered, and are then boxed in a box by stopping the suction. In Patent Document 3 as other conventional technology, a robot hand which holds at once a plurality of foods which are flowed through a previous process by a conveying device, such as a belt conveyor, and transfers the foods to a next process is disclosed. This robot hand is provided with a frame elongated by one direction at an upper part, and a plurality of gripper pillars fixed to a base plate are suspended below the frame at equal interval. A workpiece gripper is provided to a lower end of each gripper pillar.

### REFERENCE DOCUMENTS OF CONVENTIONAL ART

### Patent Documents

[Patent Document 1] JP1994-071404U
[Patent Document 2] JP2011-251702A
[Patent Document 3] JP2001-198871A

### DESCRIPTION OF THE DISCLOSURE

### Problems to be Solved by the Disclosure

However, the boxing device of Patent Document 1 can hold only two pieces of food (cucumbers) at once. For this reason, if foods, such as rice balls and sandwiches, are packed into a container by using the boxing device, the productivity may be lowered.

The boxing device of Patent Document 2 and the robot hand of Patent Document 3 can hold a plurality (6 pieces) of foods at once. However, they hold the foods in a state where the foods are laterally arranged, there is a problem that a large workspace is needed for the packing work of the foods.

Moreover, such a packing work of the foods requires accuracy of the work in each process, such as disposing the plurality of foods correctly at a given position, and holding the plurality of foods certainly, for example.

The present disclosure is made in view of solving the above problems, and one purpose thereof is to improve the efficiency of a packing work of foods, and improve the accuracy of the work, within a limited workspace.

### SUMMARY OF THE DISCLOSURE

In order to achieve the purpose described above, a holding device for food according to one aspect of the present disclosure is a holding device for food, which includes a first holding part configured to hold the food in a first posture where a given first surface of the food is oriented horizontally, and configured to be changeable of the posture of the food from the first posture into a second posture where a second surface which is different from the first surface of the food is oriented horizontally, a food feeding part configured to sequentially feed the food held in the second posture by the first holding part to a given position, a second holding part configured to hold a plurality of foods fed to the given positions in the second posture, the foods being held so as to be laterally piled up in a given direction, a food accommodating part configured to accommodate the plurality of foods held by the second holding part into a given container, a second posture detecting part configured to detect that all the plurality of foods fed to the given positions are in the second posture, and a control part configured to control operation of the second holding part to hold the plurality of foods in the second posture so that the foods are piled up in the given direction, when the second posture detecting part detects that all the plurality of foods are in the second posture at the given positions.

According to this structure, the food is first held in the first posture (e.g., a flat posture) where the first surface of the food (e.g., a triangular surface of a triangular rice ball) is oriented horizontally. Next, the posture of the food is changed from the first posture into the second posture (a standing posture) where the second surface of the food (e.g., a side surface of the triangular rice ball) is oriented horizontally. Then, the food held in the second posture is sequentially fed to the given position. Since the plurality of foods in the second posture are held in the piled-up manner only when it is detected that all the plurality of foods are in the second posture at the given positions, the plurality of held foods are securely held and accommodated into the given container. Thus, the efficiency of a packing work of foods is improved, and the accuracy of the work is improved, even within a limited workspace. Further, the second posture detecting part may include a photoelectric sensor, a camera, or other detectors, such as an ultrasonic sensor or a limit switch.

The second posture detecting part may further includes a light source unit configured to emit a plurality of parallel lights in a direction intersecting with the given direction, the plurality of parallel lights being irradiated at positions corresponding to the respective foods in the second posture at the given positions, a photoreceiving unit configured to receive the parallel lights irradiated by the light source unit, and a second posture determining part configured to determine whether the plurality of foods are in the second posture based on a detection result of the parallel lights by the photoreceiving unit.

According to this structure, since the photoelectric sensor which can detect, by the photoreceiving unit, the parallel lights (e.g., transmitted light or reflected light) irradiated by the light source unit, based on the detection result, whether the plurality of foods are in the second posture can be determined. Note that the parallel light means light which goes straight in one direction, without diffusing or converging.

The light source unit may include a plurality of first light sources configured to emit a plurality of first parallel lights in the direction perpendicular to the given direction, the plurality of first parallel lights being irradiated at positions corresponding to upper parts of the plurality of foods in the second posture at the given positions, and a plurality of second light sources configured to emit a plurality of second parallel lights in the direction perpendicular to the given direction, the plurality of second parallel lights being irradiated at positions corresponding to lower parts of the plurality of foods in the second posture at the given positions. The photoreceiving unit may further include a plurality of first photoreceiving parts configured to receive the plurality of first parallel lights passing through the positions corresponding to the upper parts of the plurality of foods, and a plurality of second photoreceiving parts configured to receive the plurality of second parallel lights passing through the positions corresponding to the lower parts of the plurality of foods. The second posture determining part may determine that all the plurality of foods are in the second posture at the given positions, when none of the plurality of first photoreceiving parts receives the plurality of first parallel lights by all the plurality of first parallel lights being interrupted by the upper parts of the plurality of foods in the second posture at the given positions, and none of the plurality of second photoreceiving parts receives the plurality of second parallel lights by all the plurality of second parallel lights being interrupted by the lower parts of the plurality of foods in the second posture at the given positions. When at least one of the plurality of first parallel lights passes through the position corresponding to the upper part of the food, and at least one of the plurality of first photoreceiving parts receives the first parallel light, the second posture determining part may determine that the food corresponding to the received first parallel light is not in the second posture at the given position.

According to this structure, when none of the plurality of second photoreceiving parts receives the plurality of first parallel lights by all the plurality of first parallel lights being interrupted by the upper parts of the plurality of foods in the second posture at the given positions, and none of the plurality of second photoreceiving parts receives the plurality of second parallel lights by all the plurality of second parallel lights being interrupted by the lower parts of the plurality of foods in the second posture at the given positions, it can be determined that all the plurality of foods are in the second posture (a standing posture) at the given positions. Whereas, when at least one of the plurality of first parallel lights passes through the position corresponding to the upper part of the food, and at least one of the plurality of first photoreceiving parts receives the first parallel light, it can be determined that the food corresponding to the received first parallel light is not in the second posture (the standing posture) at the given position. In this manner, the second posture of foods can be detected using the principle of the transmission-type photoelectric sensor. Note that the detection function of the second posture of foods can be realized by a transmission-type photoelectric sensor or a reflection-type photoelectric sensor.

The holding device may further include a second hold detector configured to detect that all the plurality of foods are held by the second holding part. When the second hold detector detects that all the plurality of foods are held, the control part controls the operation of the food accommodating part to accommodate the plurality of foods held by the second holding part into the given container.

According to this structure, the state where all the plurality of foods are held by the second holding part is detected. Only when the state where all the plurality of foods are held is detected, the plurality of foods are accommodated into the given container. Thus, the certainty of the packing work improves.

The second hold detector may further include a plurality of reflection-type photoelectric sensors configured to detect that each of the plurality of foods is held, and a second hold determining part configured to determine whether the foods are held based on detection results of the respective reflection-type photoelectric sensors.

According to this structure, whether the plurality of foods are held is determined based on detection results of the plurality of reflection-type photoelectric sensors. Note that the second hold determining part may include a transmission-type photoelectric sensor, or other detectors, such as a limit switch.

The second holding part may further include a plurality of pairs of holding members configured to hold the respective foods laterally piled up in the second posture at the given positions, and actuator members configured to drive the respective pairs of holding members so that a mutual angle of each of the pairs of holding members becomes one of a first angle at which the pair of holding members hold the food and a second angle at which the pair of holding members release the food. The first angle may be a given angle at which the pair of holding members pinch the food from both sides. The second angle may be a given angle at which a height at tip ends of the pair of holding members becomes higher than a height of the food, when the pair of holding members open.

According to this structure, since the holding members can be driven so as to be the angle (e.g., 180 degree) so that the height at the tip ends of the pair of holding members when they open becomes higher than the height of the food, it is easy to detect whether the foods are in the second posture by a sensor, for example, before the holding operation.

The second holding part may be configured to independently hold each of the plurality of the food.

A holding device for food according to another aspect of the present disclosure is a holding device for food, which includes a first holding part configured to hold the food in a first posture where a given first surface of the food is oriented horizontally, and change the posture of the food from the first posture into a second posture where a second surface different from the first surface of the food is oriented horizontally, a food feeding part configured to sequentially feed the food held in the second posture by the first holding part to a given position, a second holding part configured to hold a plurality of foods fed to the given positions in the second posture, the food being held so as to be laterally piled up in a given direction, and a food accommodating part configured to accommodate the plurality of foods held by the second holding part into a given container. The second holding part includes a plurality of pairs of holding members configured to hold the respective foods laterally piled up in the second posture at the given positions, actuator members configured to independently drive the respective pairs of holding members so that a mutual angle of each of the pairs of holding members becomes one of a first angle at which the pair of holding members hold the food and a second angle at which the pair of holding members release the food. The first angle is a given angle at which the pair of holding members pinch the food from both sides. The second angle is a given angle at which a height at tip ends of the pair of holding members becomes higher than a height of the food, when the pair of holding members open.

According to this structure, the food is first held in the first posture (e.g., a flat posture) where the first surface of the food (e.g., a triangular surface of a triangular rice ball) is oriented horizontally. Next, the posture of the food is changed from the first posture into the second posture (a standing posture) where the second surface of the food (e.g., a side surface of the triangular rice ball) is oriented horizontally. Then, the food held in the second posture is sequentially fed to the given position. The plurality of foods fed to the given position in the second posture are held in the piled-up manner. At the end, the plurality of held foods are accommodated into the given container. Thus, the efficiency of the packing work of the foods is improved, even within a limited workspace.

Further, since the respective pairs of holding members configured to hold the respective foods can be independently driven by the actuator members, the holding operation can be performed by, for example, suitably changing the number of foods holding. In this case, when the holding member 32 to be driven is changed to accommodate the foods in the container, the second angle of the non-driven holding member is fixed to the given angle so that the height at the tip ends of the pair of holding members when they open becomes higher than the height of the food. Thus, it can prevent that the non-driven holding members interfere with the other foods accommodated in the container. Thus, the certainty of the work improves.

The holding device may further include a control part configured to control the actuator members so that the mutual angle of a prespecified number of the pairs of holding members among the plurality of pairs of holding members becomes one of the first angle and the second angle, and control the actuator members so that, when any non-specified pair of holding members exists, the mutual angle of the non-specified pair of holding members is fixed to the second angle. The control part may control the food accommodating part to accommodate the foods held by the prespecified pairs of holding members into the given container.

According to this structure, the holding operation can be performed by suitably changing the number of holding foods. For example, in a case where the second holding member includes five pairs of holding members, by driving all the five pairs of holding members, the food can be packed in the laterally piled-up manner into the container in which 50 pieces of food (10×5) can be accommodated. Further, by fixing a pair of holding members to the second angle and driving only the remaining four pair of the holding members, the food can be packed in the laterally piled-up manner into the container in which 40 pieces of food (8×5)) can be accommodated. Therefore, the packing work is flexibly applicable to any food containers having different storage capacities.

The holding device may further include a control part configured to control the actuator members so that the number of pairs of holding members to drive is reduced according to an empty space for the food in the given container and the mutual angle of the remaining pair of holding members becomes one of the first angle and the second angle, and when the reduced pair of holding members exists, control the actuator members so that the mutual angle of the reduced pair of holding members is fixed to the second angle. The control part may control the food accommodating part to accommodate the food held by the remaining pair of holding members into the given container.

According to this structure, the holding operation can be performed by suitably changing the number of holding foods according to an empty space for the food in the given container. In a case where the second holding member includes five pairs of holding members, when only four empty spaces for foods in the food container exist, a pair of holding members may be fixed to the second angle and only the remaining four pair of the holding members may be driven. Buy alternately driving five pairs of holding members and four pairs of holding members, the food can be packed in the laterally piled-up manner into the container in which 45 pieces of food (9×5) can be accommodated. Therefore, the packing work is flexibly applicable to any food containers having different storage capacities.

The holding device may be comprised of a robot including a first arm having the first holding part at a tip end thereof, and a second arm having the second holding part at a tip end thereof.

### Effect of the Disclosure

The present disclosure has the structure described above, and can realize the improvement of the efficiency of the packing work of the foods, and the improvement of the accuracy of the work, within the limited workspace. The purpose of the present disclosure, other purposes, features, and advantages will be clarified from the detailed description of the following suitable embodiments with reference to the accompanying drawings.

### BRIEF DESCRIPTION OF DRAWINGS

FIG. 1 is a plan view schematically illustrating the entire structure of a holding device for food according to a first embodiment of the present disclosure.

FIG. 2 is a perspective view schematically illustrating food in FIG. 1.

FIG. 3 is a front view schematically illustrating the entire structure of one example of a robot in FIG. 1.

FIGS. 4(A) and 4(B) are views illustrating a structure of a hand part (first holding part) of the robot in FIG. 3.

FIGS. 5(A) and 5(B) are views illustrating a structure of a hand part (second holding part) of the robot in FIG. 3.

FIG. 6 is a functional block diagram schematically illustrating a configuration of a control device of the robot in FIG. 3.

FIG. 7 is a perspective view illustrating a first holding operation of food.

FIG. 8 is a perspective view illustrating a second holding operation of food.

FIG. 9 is a perspective view illustrating a third holding operation of food.

FIG. 10 is a perspective view illustrating a fourth holding operation of food.

FIGS. 11(A) and 11(B) are views illustrating another structure of the hand part (first holding part).

FIGS. 12(A) and 12(B) are views illustrating another structure of the hand part (second holding part).

FIG. 13 is a view illustrating an evacuation operation of the hand part in FIGS. 12(A) and 12(B).

FIG. 14 is a timing chart illustrating one example of a control command of the hand part and an angle of a hand, during operation of FIG. 13.

FIGS. 15(A) and 15(B) are views illustrating a structure of a hand part (second holding part) of a holding device (robot) for food according to a second embodiment of the present disclosure (transmission-type photoelectric sensor).

FIG. 16 is a functional block diagram schematically illustrating a configuration of a control device of the robot having the hand part in FIGS. 15(A) and 15(B).

FIGS. 17(A) and 17(B) are views schematically illustrating error determination processing executed by the robot having the structure of FIGS. 15(A) and 15(B), and FIG. 16.

FIGS. 18(A) and 18(B) are views illustrating a structure according to a first modification of the holding device for food according to this embodiment (reflection-type photoelectric sensor).

FIGS. 19(A) and 19(B) are views illustrating a structure according to a second modification of the holding device for food according to this embodiment (vision sensor).

FIGS. 20(A) and 20(B) are views illustrating a structure of a hand part (second holding part) of a holding device (robot) for food according to a third embodiment of the present disclosure.

FIGS. 21(A) to 21(C) are views illustrating food containers used for a packing work of the foods by the robot having the hand part in FIGS. 18(A) and 18(B).

FIG. 22 is a view illustrating a structure according to a modification of the hand part (second holding part) in FIGS. 20(A) and 20(B).

FIGS. 23(A) and 23(B) are examples of a cross-sectional view of sheets disposed on a workbench of FIG. 1.

FIG. 24 is a view illustrating another structure of the hand part (first holding part).

### MODES FOR CARRYING OUT THE DISCLOSURE

In a first aspect of the present disclosure, a holding device for food includes a first holding part configured to hold food in a first posture where a given first surface of the food is oriented horizontally, and configured to be changeable of the posture of the food from the first posture into a second posture where a second surface which is different from the first surface of the food is oriented horizontally, a food feeding part configured to sequentially feed the food held in the second posture to a given position by the first holding part, a second holding part configured to hold a plurality of foods fed to the given position in the second posture so that the foods are piled up in a given direction, and a food accommodating part which accommodates the plurality of foods held by the second holding part into a given container.

According to this structure, the food is first held in the first posture (e.g., a flat posture) where the first surface of the food (e.g., a triangular surface of a triangular rice ball) is oriented horizontally. Next, the posture of the food is changed from the first posture into the second posture (a standing posture) where the second surface of the food (e.g., a side surface of the triangular rice ball) is oriented horizontally. Then, the food held in the second posture is sequentially fed to the given position. The plurality of foods fed to the given position in the second posture are held in the piled-up manner. At the end, the plurality of held foods are accommodated into the given container. Thus, the efficiency of the packing work of the foods is improved, even within a limited workspace.

In a second aspect of the present disclosure, the first holding part may include a base part, a rotary joint having a horizontal rotation axis, a tip-end part rotatably coupled via the rotary joint to the base part, and one or more holding heads which is provided to the tip-end part and holds the food(s).

According to this structure, the food in the first posture is held by the holding head provided to the tip-end part of the first holding part, and the posture of the food can be changed from the first posture into the second posture by rotating the tip-end part via the rotary joint, for example, by 90 degrees with respect to the base part.

In a third aspect of the present disclosure, the holding head may be a suction head which sucks and holds the food at the first surface, and the first holding part may further include a supporting member which is provided to the tip-end part, and supports the food sucked by the suction head by contacting the second surface.

According to this structure, a wrapping portion of the food is sucked and held by the suction head, and a main part of the food is supported by the supporting member. Thus, it is easy to maintain a stable posture of the food when changing the posture of the food.

In a fourth aspect of the present disclosure, the second holding part may include a plurality of pairs of holding members each configured to hold the respective foods laterally piled up in the second posture at the given positions.

According to this structure, the plurality of foods are collectively held efficiently.

In a fifth aspect of the present disclosure, the second holding part may further include an actuator member which drives the plurality of pairs of holding members so that a mutual angle of each pair of holding members becomes either angle of a given first angle at which the food can be held by pinching each food from both sides, and a given second angle of 180 degrees or more at which each food can be released.

According to this structure, since each pair of holding members are controlled before and after the holding operation of the food so that the mutual angle becomes 180 degrees or more, it is easy to check a state of the food visually or by a sensor. Moreover, since the opening-and-closing angle only has the two values (e.g., 60 degrees and 180 degrees), a complicated control is not required.

In a sixth aspect of the present disclosure, the holding device for food may further include a control part which outputs a hold command or a release command to achieve the first angle or the second angle, respectively, to the actuator member. When evacuating from the given container the second holding part which accommodated the plurality of foods into the given container, the control part may change an output from the hold command to the release command, and may then change the output from the release command to the hold command at a timing where the mutual angle of each pair of holding members does not exceed a given third angle which is larger than the first angle and smaller than the second angle.

According to this structure, the control part controls the mutual angle of each pair of holding members during the evacuation operation of the second holding part by controlling an output timing of the control command to the actuator member. Thus, it can be avoided that, during the evacuation operation of the second holding part, the holding member collides with an inner wall of the given container or an adjacent food.

In a seventh aspect of the present disclosure, the holding device for food may further include a sheet disposed at the given position, and the sheet may have convex parts provided in the given direction to support, in a cross-sectional view in the given direction, the respective foods lined up in the given direction in the second posture. According to this structure, the posture (second posture) of each food on the sheet can be stabilized by having the plurality of convex parts. Therefore, it is easy to hold the plurality of foods piled up in the given direction.

In an eighth aspect of the present disclosure, the sheet may have steps provided, in the cross-sectional view in the given direction, so as to support the respective foods lined up in the given direction in the second posture, while causing the foods to incline in the given direction.

In a ninth aspect of the present disclosure, the food may have the first surface and the second surface perpendicular to the first surface, the first posture may be a posture where the first surface of the food faces downwardly, and the second posture may be a posture where the second surface of the food faces downwardly. Note that the phrase “the first surface and the second surface are perpendicular to each other” as used herein permits a slight inclination caused by the surface of the food or wrapping, without being limited to a strict perpendicularity. The food may be, for example, a handmade rice ball of a triangular shape having triangular first surfaces and rectangular second surfaces.

Before shipment of the foods, a foreign matter inspection of the foods is obligated for the safety of the foods. Generally, since X-rays are emitted to the food from above in an inspection device, if the triangular handmade rice ball is used, a flat posture where the triangular surface faces downwardly is suitable. According to this structure, for example, the food passes through the inspection device, while being conveyed by a conveyor in a production line in the flat posture (first posture) where the triangular surface of the food faces downwardly, and the plurality of foods can then be collectively packed in the standing posture (second posture) where the rectangular surface of the food faces downwardly by the holding device for the food.

In a tenth aspect of the present disclosure, the holding device may be configured by a robot including a first arm having the first holding part at a tip end and a second arm having the second holding part at a tip end.

According to this structure, the packing work of the foods is realized by a dual-arm robot.

Hereinafter, desirable embodiments will be described with reference to the drawings. Note that, in the following, the same reference characters are assigned to the same or corresponding components throughout the drawings to omit redundant description. Moreover, each component is illustrated schematically in the drawings in order to facilitate understandings. Further, a direction in which a pair of arms extend is referred to as a “left-and-right direction,” a direction parallel to an axial center of a base shaft is referred to as an “up-and-down direction,” and a direction perpendicular to the left-and-right direction and the up-and-down direction is referred to as a “front-and-rear direction.”

### First Embodiment

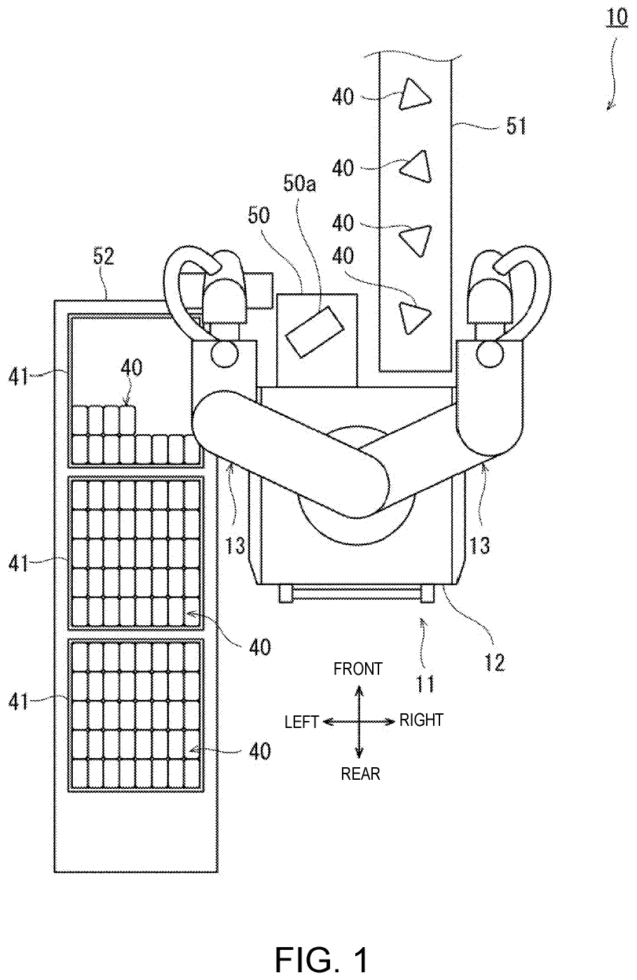

FIG. 1 is a plan view schematically illustrating the entire structure of a holding device 10 for food 40 according to a first embodiment of the present disclosure. As illustrated in FIG. 1, the holding device 10 for the food 40 is used for a packing work of a plurality of foods 40 into a tray 41. In this embodiment, a case where the holding device 10 for the food 40 according to the present disclosure is comprised of a robot 11 will be described. The robot 11 is a dual-arm robot having a pair of robot arms 13 supported by a base 12. Note that the holding device 10 for the food 40 is not limited to this configuration comprised of the robot 11. Note that, although, as the robot 11, a horizontal articulated dual-arm robot will be described, other robots, such as a horizontal articulated or a vertical articulated robot, may also be employed. The robot 11 can be installed within a limited space corresponding to one person (e.g., 610 mm×620 mm).

A workbench 50 for the robot 11 is disposed in front of, and on the left side of the robot 11. The workbench 50 has a substantially square shape in the plan view, and is attached to the front surface of the base 12. A sheet 50a having a rectangular shape in the plan view is disposed at a given position on the workbench 50. A first belt conveyor 51 is disposed in front of the robot 11, and a second belt conveyor 52 is disposed at the left side of the robot 11. In this embodiment, a “workspace” of the pair of robot arms 13 is an area, in the plan view, which covers the workbench 50, a part of the first belt conveyor 51 on the robot 11 side, and the second belt conveyor 52. The first belt conveyor 51 is a device which transfers the food 40 from a location forward of the robot 11 to a closer location of the robot 11, and extends in the front-and-rear direction. The second belt conveyor 52 is a device which transfers the tray 41 from a location on the left side of the robot 11 to a location rearward, and extends in the front-and-rear direction. Moreover, although the tray 41 is a container which can accommodate forty pieces of the foods (8 rows×5 columns) 40 in this example, the storage capacity of the tray 41 is not limited to this size. Moreover, other containers, which open upwardly, may also be used.

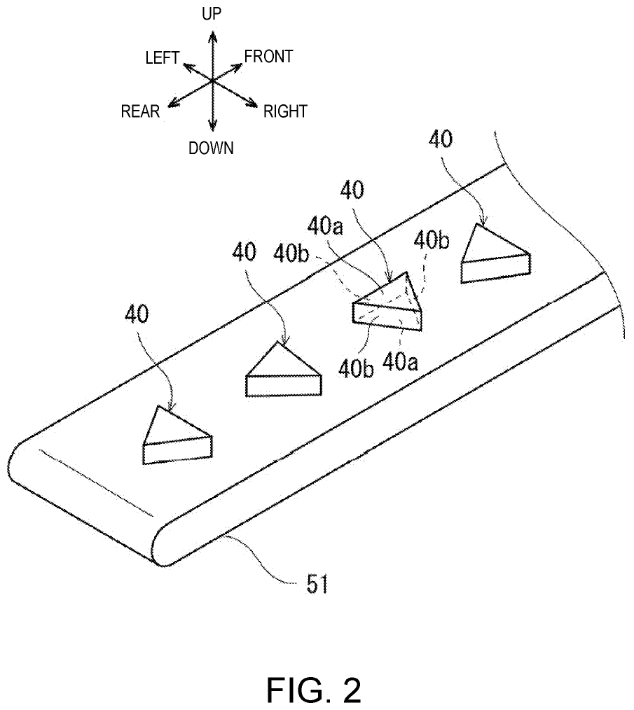

Moreover, the food 40 is food having a constant shape, for example, a rice ball or a sandwich. FIG. 2 is a perspective view schematically illustrating the food 40 in FIG. 1. As illustrated in FIG. 2, each food 40 has first surface parts 40a and second surface parts 40b perpendicular to the first surface parts 40a. The food 40 in this embodiment is a triangular rice ball wrapped with a film. The first surface parts 40a of the food 40 are comprised of two mutually-parallel triangular planes. The second surface parts 40b of the food 40 are comprised of three rectangular planes provided to three sides surrounding the perimeter of the first surface parts 40a. Note that the phrase “the first surface part 40a and the second surface part 40b are perpendicular to each other,” or “the first surface parts 40a are parallel to each other” does not limit the mutual angle to the strict perpendicularity or parallelism, but permits a slight inclination caused by the surface of the food 40 or the wrapping. Although the rice ball wrapped with the film typically projects the film from the upper part thereof in order to facilitate opening of the film, illustration of the film in the upper part is omitted.

In this embodiment, the food 40 is conveyed on the first belt conveyor 51 in the first posture where the first surface part 40a is oriented horizontally. The first posture is the flat posture where the triangular-shaped first surface part 40a of the food 40 is oriented downwardly. Generally, before the shipment of the foods 40, a foreign substance inspection is conducted for securing the safety. For example, in the X-ray inspection, since X-rays are emitted to the food 40 from above, the flat posture is a suitable posture for the food 40. In this embodiment, the food 40 is conveyed in the flat posture on the first belt conveyor 51 and passes through a location below an inspection device (not illustrated). Then, the posture of the food 40 is changed from the first posture into the second posture where the second surface part 40b is oriented horizontally, by the holding device 10 for the food 40 as will be described later. The second posture is the standing posture where the rectangular-shaped second surface part 40b of the food 40 is oriented downwardly.

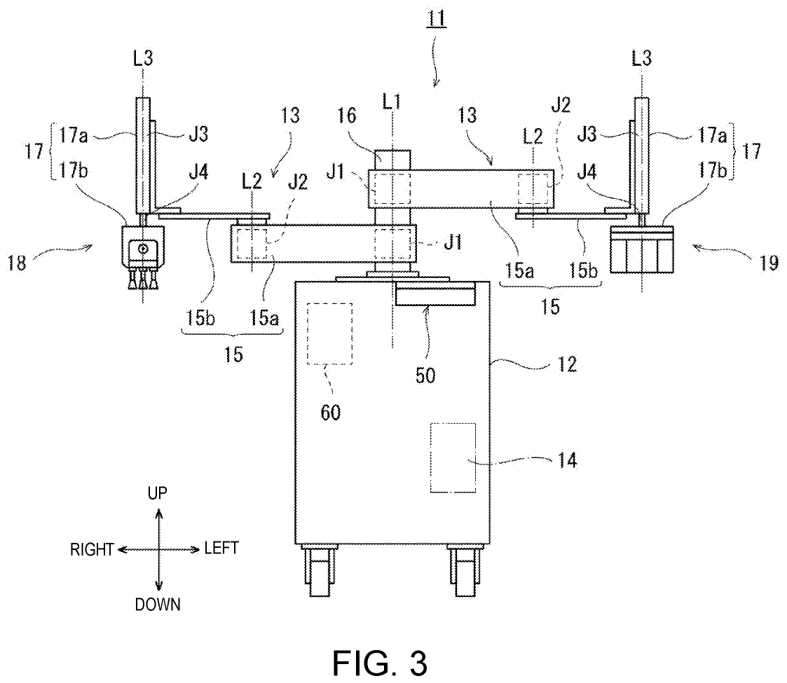

FIG. 3 is a front view schematically illustrating the entire structure of one example of the robot 11. As illustrated in FIG. 3, the robot 11 includes the base 12 fixed to a carriage, a pair of robot arms (hereinafter, may simply be referred to as the “arms”) 13 supported by the base 12, a control device 14 accommodated in the base 12, and a vacuum generator 60. The vacuum generator 60 is, for example, a device which generates negative pressure at suction heads 22 described later, such as a vacuum pump and CONVUM®. Each arm 13 is a horizontal articulated robot arm configured to be movable with respect to the base 12, and is provided with an arm part 15, a wrist part 17, and hand parts 18 or 19. Note that the right arm 13 and the left arm 13 may have substantially the same structure. Moreover, the right arm 13 and the left arm 13 are capable of operating independently or collaborately.

In this example, each arm part 15 is comprised of a first link 15a and a second link 15b. The first link 15a is coupled to a base shaft 16 fixed to an upper surface of the base 12 via a rotary joint J1, and is rotatable about a rotation axis L1 passing through an axial center of the base shaft 16. The second link 15b which is coupled to a tip end of the first link 15a via a rotary joint J2, and is rotatable about a rotation axis L2 defined at the tip end of the first link 15a.

The wrist part 17 is comprised of an elevating part 17a and a rotary part 17b. The elevating part 17a is coupled to a tip end of the second link 15b via a linear-motion joint J3, and is capable of ascending and descending with respect to the second link 15b. The rotary part 17b is coupled to a lower end of the elevating part 17a via a rotary joint J4, and is rotatable about a rotation axis L3 defined at a lower end of the elevating part 17a.

The right hand part 18 and the left hand part 19 are each coupled to the rotary part 17b of the wrist part 17. The right hand part 18 is provided to a tip end of the right arm 13, and the left hand part 19 is provided to a tip end of the left arm 13. Note that the right hand part 18 corresponds to a “first holding part” of the present disclosure, and the left hand part 19 corresponds to a “second holding part” of the present disclosure. Moreover, the right arm 13 corresponds to a “food feeding part” of the present disclosure, and the left arm 13 corresponds to a “food accommodating part” of the present disclosure.

Each arm 13 having the above structure has the joints J1-J4. Each arm 13 is provided, corresponding to the joints J1-J4, with servo motors (not illustrated) for driving the joints, and encoders (not illustrated) which detect rotational angles of the servo motors. Moreover, the rotation axes L1 of the first links 15a of the two arms 13 are located on the same straight line, and the first link 15a of one of the arms 13 and the first link 15a of the other arm 13 are disposed with a height difference therebetween.

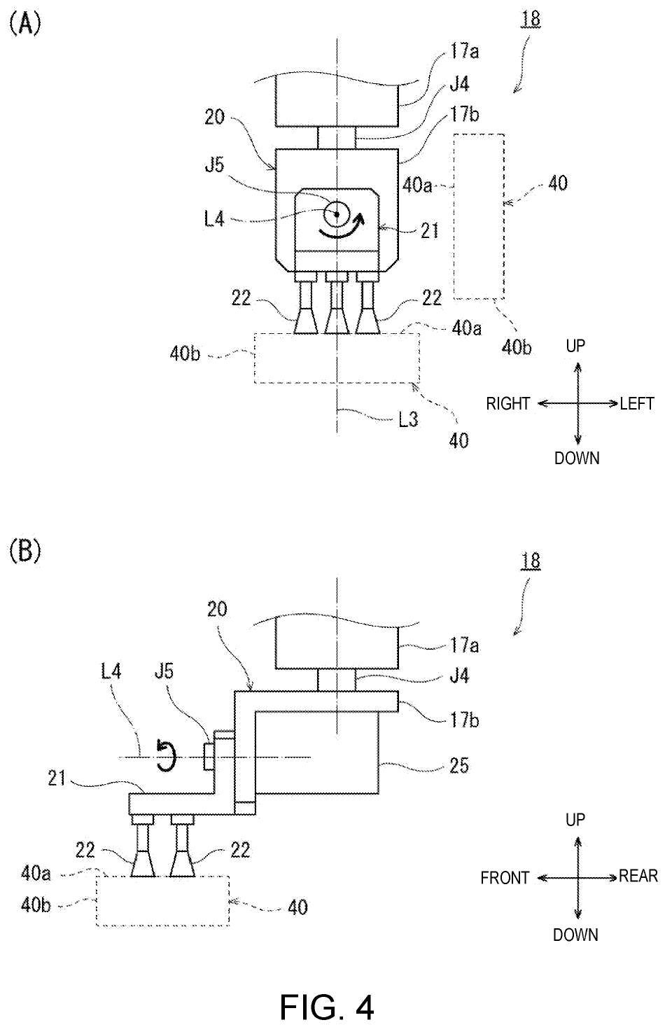

FIGS. 4(A) and 4(B) are a front view and a side view, respectively, illustrating a structure of the right hand part 18 (first holding part) in FIG. 3. The right hand part 18 is constructed to hold the food 40 in the first posture where the first surface part 40a is oriented horizontally, and to be changeable of the posture of the food 40 from the first posture into the second posture where the second surface part 40b is oriented horizontally. The right hand part 18 has a base part 20 including the rotary part 17b of the wrist part 17, the rotary joint J5 having a horizontal rotation axis L4, a tip-end part 21 rotatably coupled to the base part 20, and suction heads 22 which are provided to the tip-end part 21 and suck the food 40 (first surface part 40a).

The base part 20 is coupled to the elevating part 17a of the wrist part 17 via the rotary joint J4, and is coupled to the tip-end part 21 via a rotary joint J5. The base part 20 is bent into a substantially L-shape in the side view (see FIG. 4(B)). The base part 20 has an actuator 25 of the rotary joint J5 inside the L-shape member.

The tip-end part 21 is coupled to the base part 20 via the rotary joint J5, to which the suction heads 22 are attached. The tip-end part 21 is bent into a substantially L-shape in the side view (see FIG. 4(B)). In this embodiment, three suction heads 22 having the same length are provided at different locations in a back side of a tip-end surface 22b. Contact surfaces of the three suction heads 22 are constructed so as to contact the first surface part 40a of the food 40 at three points which are not located on a straight line in the first surface part 40a. As illustrated in the drawings, the posture of the contact surfaces of the suction heads 22 where the contact surfaces face downwardly is referred to as a reference posture of the suction heads 22. The suction heads 22 are connected with the vacuum generator 60 (see FIG. 1) via piping (not illustrated). The piping is provided, for example, with an on-off valve (not illustrated). By opening and closing the piping by the on-off valve, suction by the suction and release of the suction heads 22 are performed.

Thus, the food 40 in the first posture is sucked and held by the suction heads 22 provided to the tip-end part 21 of the right hand part 18, and the food 40 can be changed in the posture from the first posture into the second posture by rotating the tip-end part 21 via the rotary joint J5 by 90 degrees with respect to the base part 20.

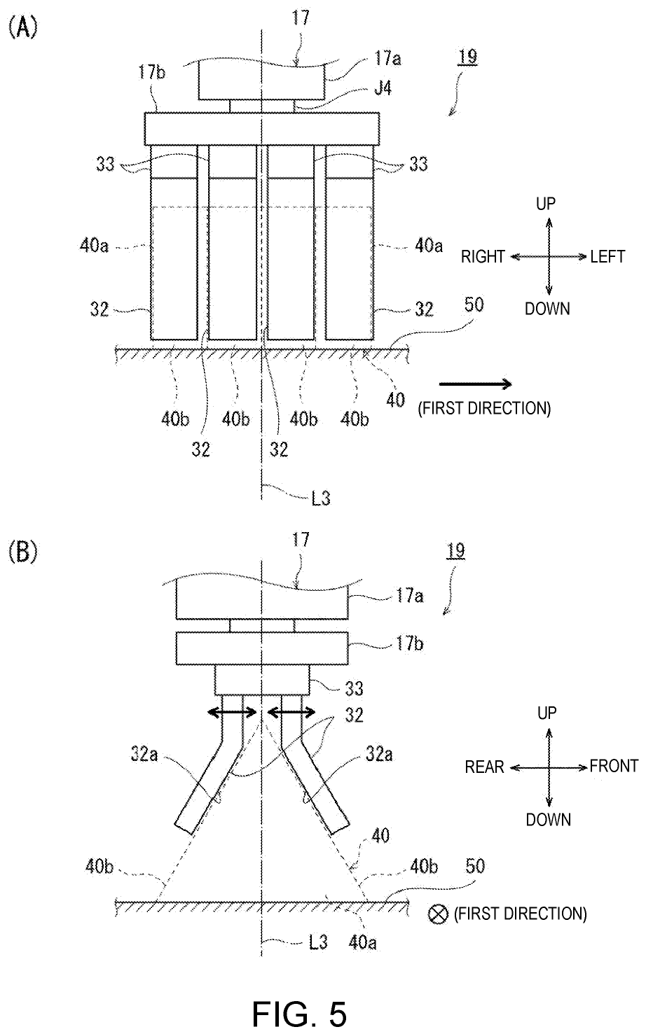

FIGS. 5(A) and 5(B) are a front view and a side view illustrating a structure of the left hand part 19 (second holding part) in FIG. 3. As illustrated in FIGS. 5(A) and 5(B), the left hand part 19 is constructed to hold four pieces of food 40 in a laterally piled-up manner so that the first surface part 40a of each food 40 fed in the second posture at given positions on the workbench 50 face in the first direction. The first direction is the left-and-right direction in FIGS. 5(A) and 5(B). The left hand part 19 has four pairs of holding members 32 lined up in the first direction, and four actuator members 33 each capable of independently driving the respective pairs of holding members 32. The rotary part 17b of the wrist part 17 extends in the horizontal direction perpendicular to the rotation axis L3 in the front view. Each holding member 32 is connected with the rotary part 17b of the wrist part 17 via the respective actuator member 33.

At the given position on the workbench 50, each pair of holding members 32 is constructed to hold each of the foods 40 laterally piled up in the second posture where the first surface part 40a faces in the first direction.

In this embodiment, each pair of holding members 32 is constructed to pinch the second surface parts 40b of the food 40 from both sides. Each holding member 32 has a contact surface 32a which has the shape corresponding to the inclination of the second surface part 40b of the food 40, and contacts the food 40. The holding member 32 is, for example, a rectangular flat-plate shape, and has two opposite flat principal surfaces. One of the principal surfaces is the contact surface 32a which contacts the food 40 held by the holding members 32. The holding member 32 may be formed by, for example, a resin plate or a metal plate. In this embodiment, since the triangular rice ball is used as the food 40, each pair of holding members 32 is provided so as to reduce the mutual distance toward upper end parts thereof, and is formed in a mountain shape which spreads downwardly (an inverted V-shape).

Each actuator member 33 drives the corresponding pair of holding members 32. The actuator member 33 is connected to an actuator (not illustrated) etc. The actuator is connected to an upper end side of the pair of holding members 32 so that the mutual distance of the pair of holding members 32 changes by linearly moving the actuator member 33. By the actuator member 33, the pair of holding members 32 reduces the mutual distance to pinch and hold one piece of food 40. In this embodiment, the pair of holding members 32 are controlled so that the mutual distance is widened and narrowed in the arrow direction in FIG. 5(B), while the mutual angle is maintained at an angle corresponding to the inclinations of the second surface parts 40b of the food 40 (about 60 degrees). Although in this embodiment the food 40 is held by the frictional force caused by contacting the contact surfaces 32a of the holding members 32 with the second surface parts 40b of the food 40, suction port(s) may be formed in the contact surface(s) 32a to hold the food 40 by the suction force.

Note that this embodiment is configured to form a gap in the upper parts of the left and right holding members 32 when holding the food 40. Thus, the holding members 32 do not touch the film in the upper part of the rice ball (40). Typically, in the rice ball wrapped with the film, the film in the upper part is made easier to be torn by perforations etc. formed in order to facilitate an easier opening of the film, the above structure of the holding members 32 will not accidentally open food 40 nor damage the food 40.

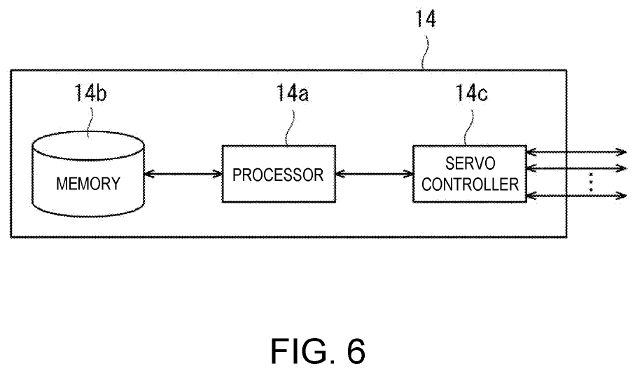

FIG. 6 is a functional block diagram schematically illustrating a configuration of the control device 14 of the robot 11 in FIG. 3. As illustrated in FIG. 5, the control device 14 includes a processor 14a, such as a CPU, a memory 14b, such as a ROM and/or RAM, and a servo controller 14c. The control device 14 is a robot controller provided with a computer, such as a microcontroller. Note that the control device 14 may be comprised of a single control device 14 which carries out a centralized control, or may be comprised of a plurality of control devices 14 which collaboratively carry out a distributed control.

The memory 14b stores information on a basic program which functions as the robot controller, various fixed data, etc. The processor 14a controls various operations of the robot 11 by reading and executing software, such as the basic program, stored in the memory 14b. That is, the processor 14a generates a control command for the robot 11, and then outputs it to the servo controller 14c. Based on the control command generated by the processor 14a, the servo controller 14c controls the driving of the servo motors corresponding to the joints J1-J5 of each arm 13 of the robot 11.

The control device 14 also controls operation of the vacuum generator 60 (see FIG. 1), and the opening and closing of the on-off valve. When opening and closing the on-off valve to open and close the piping, the suction and release of the suction heads 22 are performed.

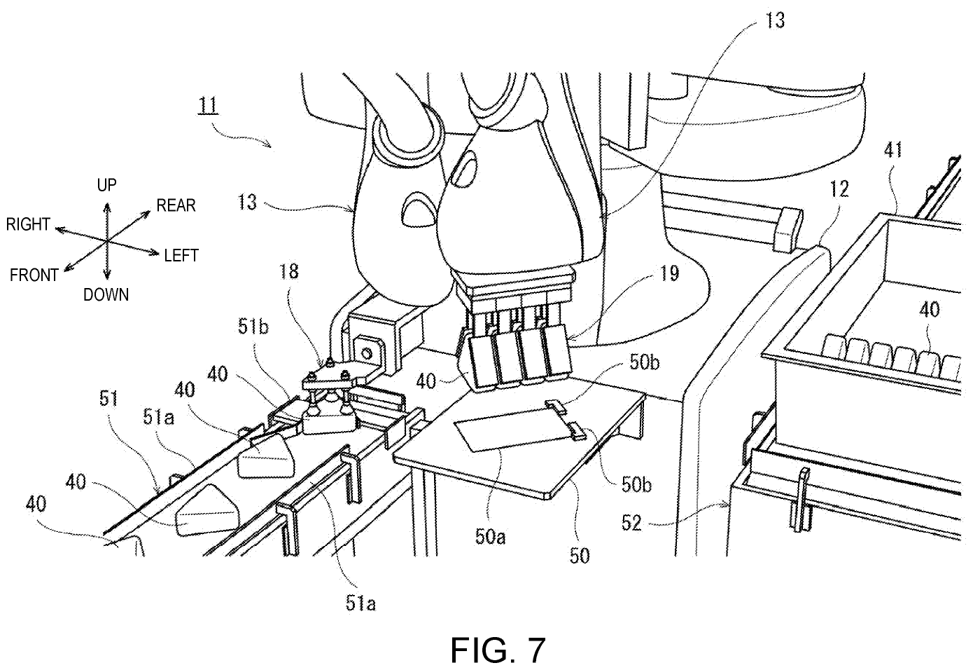

Next, a holding operation of the food(s) 40 in this embodiment is described with reference to FIGS. 7 to 10. In this embodiment, each food 40 is conveyed on the first belt conveyor 51 in the first posture where the first surface part 40a is oriented horizontally. A pair of side walls 51a are provided at both sides of the first belt conveyor 51 in the conveyance direction. The pair of side walls 51a regulates a flow of the conveying objects. A stop 51b is provided at an end of the first belt conveyor 51. The stop 51b blocks the flow of the food 40 being conveyed in the first posture. In a plan view, a rectangular sheet 50a and a pair of supporting members 50b which support the food 40 are disposed at given positions of the workbench 50 attached to the front side of the base 12.

First, as illustrated in FIG. 7, the control device 14 controls the operation of the right arm 13 to align the right hand part 18 (the position of the wrist part 17) with an approximate location above the stop 51b at the end of the first belt conveyor 51. Then, the control device 14 lowers the right hand part 18 (the elevating part 17a of the wrist part 17) while the suction heads 22 are set in the reference posture until the contact surfaces of the suction heads 22 contact to the first surface part 40a of the food 40 on the first belt conveyor 51. Thus, the suction heads 22 suck and hold of the food 40 in the first posture.

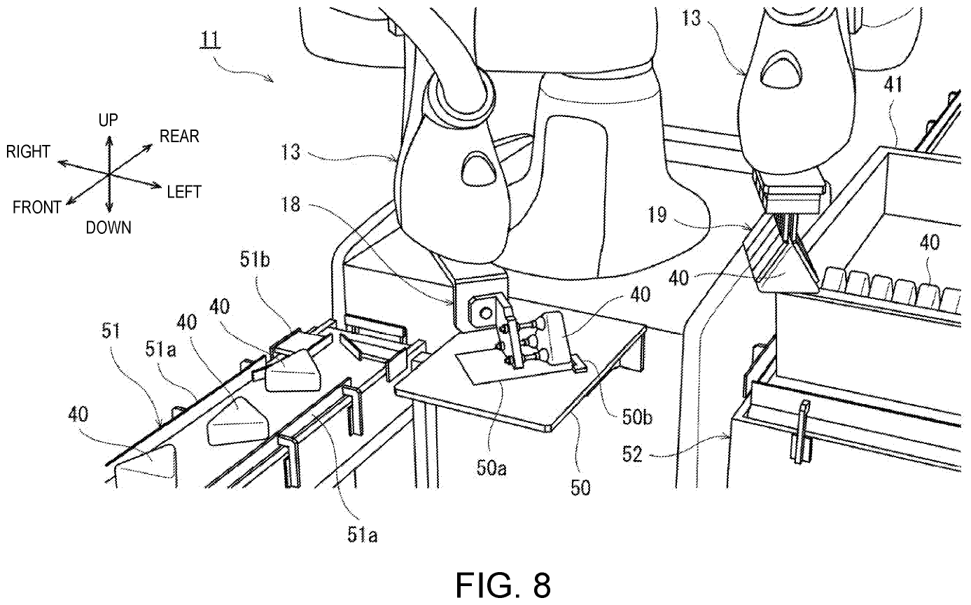

Next, as illustrated in FIG. 8, the control device 14 controls the operation of the right arm 13 to rotate the tip-end part 21 of the right hand part 18 via the rotary joint J5 about the rotation axis L4 by 90 degrees with respect to the base part 20. Thus, the suction heads 22 rotate by 90 degrees from the reference posture. The posture of the food 40 which is sucked and held by the suction heads 22 in the first posture is changed from the first posture into the second posture. Then, the control device 14 controls the operation of the right arm 13 to feed the food 40 held in the second posture by the right hand part 18 to a position on the sheet 50a placed on the workbench 50. By repeating the above operations, four pieces of food 40 are sequentially fed to respective positions on the sheet 50a placed on the workbench 50.

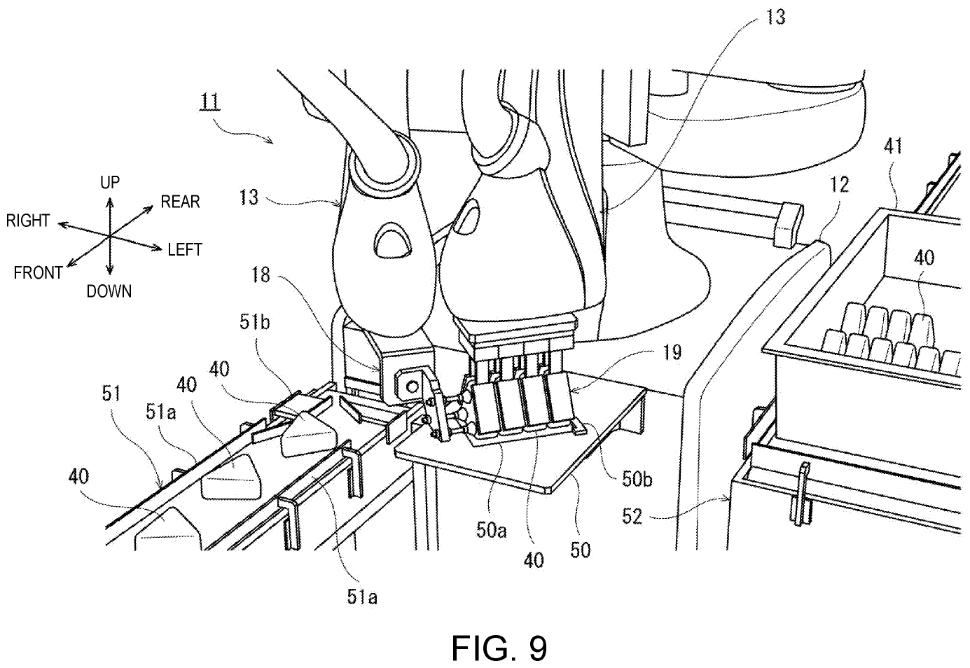

Next, as illustrated in FIG. 9, the control device 14 controls the operation of the left arm 13 to hold four pieces of food 40 in the laterally piled-up manner where the first surface part 40a of each food 40 fed in the second posture by the left hand part 19 to the corresponding position on the sheet 50a placed on the workbench 50 faces in a given direction.

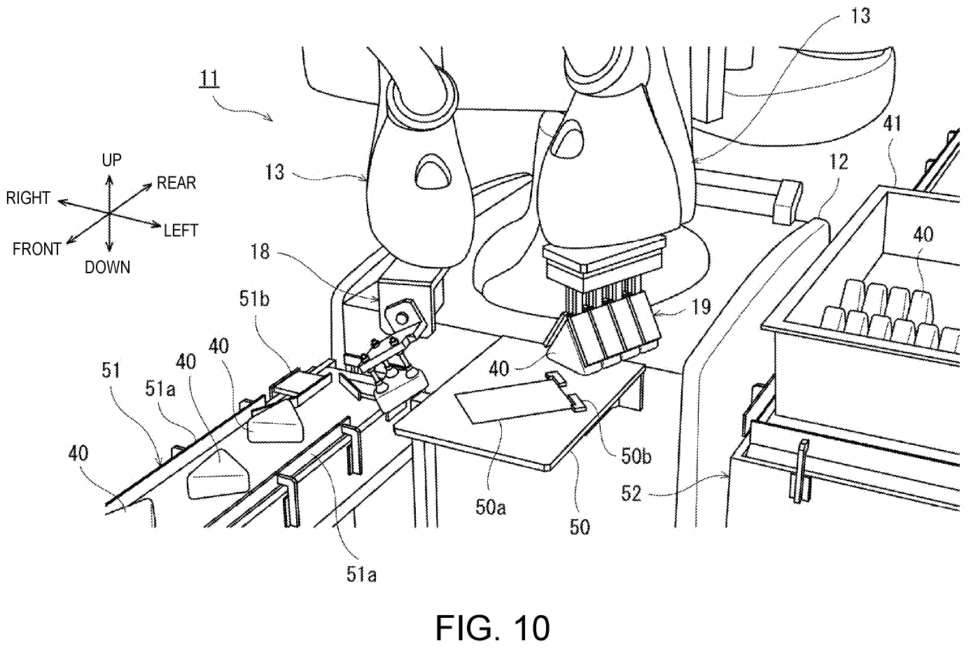

Finally, as illustrated in FIG. 10, the control device 14 controls the operation of the left arm 13 to accommodate the four pieces of food held by the left hand part 19 into the tray 41. Thus, the efficiency of the packing work of the foods 40 is improved even within the limited workspace.

### Other Embodiments

Note that in the embodiment the food 40 is sucked and held by the suction heads 22 provided to the tip-end part 21 of the right hand part 18 (see FIG. 4). Then, the posture of the food 40 is changed from the first posture into the second posture by rotating the tip-end part 21 via the rotary joint J5 by 90 degrees with respect to the base part 20. When sucking and holding the food 40 by the suction heads 22, a wrapping portion (first surface part 40a) of the food 40 is sucked, and the heavy main part of the food 40 is supported by the sucked wrapping portion. For this reason, when rotating the held food 40, the wrapping portion of the food 40 may be separated from the main part, which may result in the collapsing of the posture of the food 40.

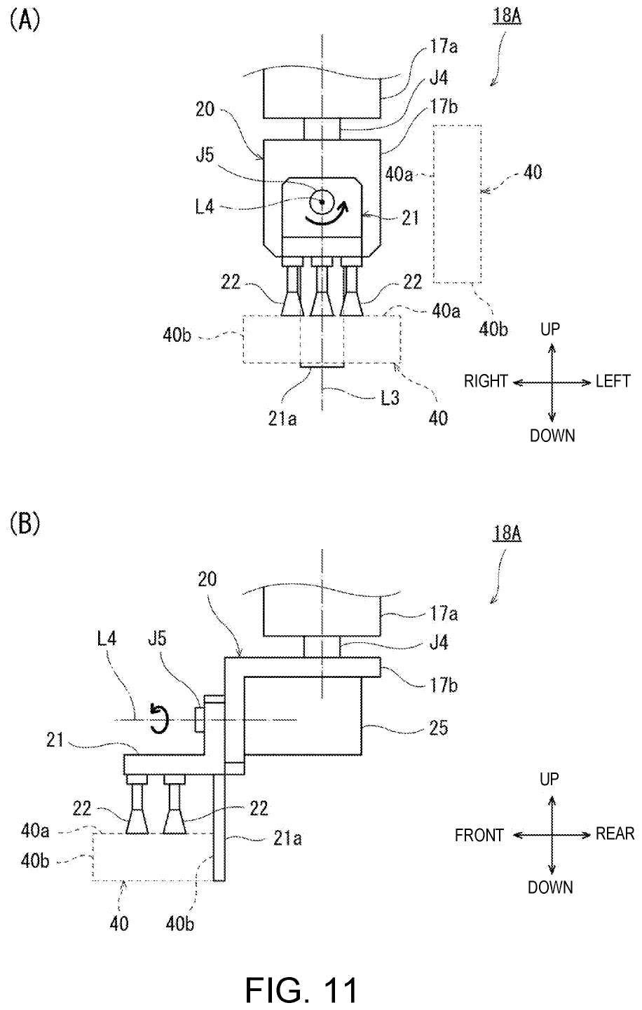

FIGS. 11(A) and 11(B) are views illustrating a structure of the right hand part 18A of another embodiment. As illustrated in FIGS. 11(A) and 11(B), the right hand part 18A further has a supporting member 21a provided to the tip-end part 21. The supporting member 21a supports the food 40 which is sucked and held by the suction heads 22. Here, the wrapping portion (first surface part 40a) of the food 40 is sucked and held by the three suction heads 22. The supporting member 21a contacts the second surface part 40b of the food 40 to support it. The supporting member 21a has a flat-plate shape. The flat plate supports a part of the second surface part 40b of the food 40. Thus, since the main part of the food 40 is supported by the supporting member 21a when the food 40 sucked and held is rotated, the posture of the food 40 is stably maintained.

Note that, in the above embodiment, the control device 14 controls the actuator members 33 so that the mutual distance of the pair of holding members 32 is widened and narrowed, while keeping the mutual angle of the pair of holding members 32 at the angle (about 60 degrees) corresponding to the inclinations of the second surface parts 40b of the food 40 (see FIG. 5(B)). However, the control device 14 may control the actuator members 33 to change the mutual angle of the pair of holding members 32.

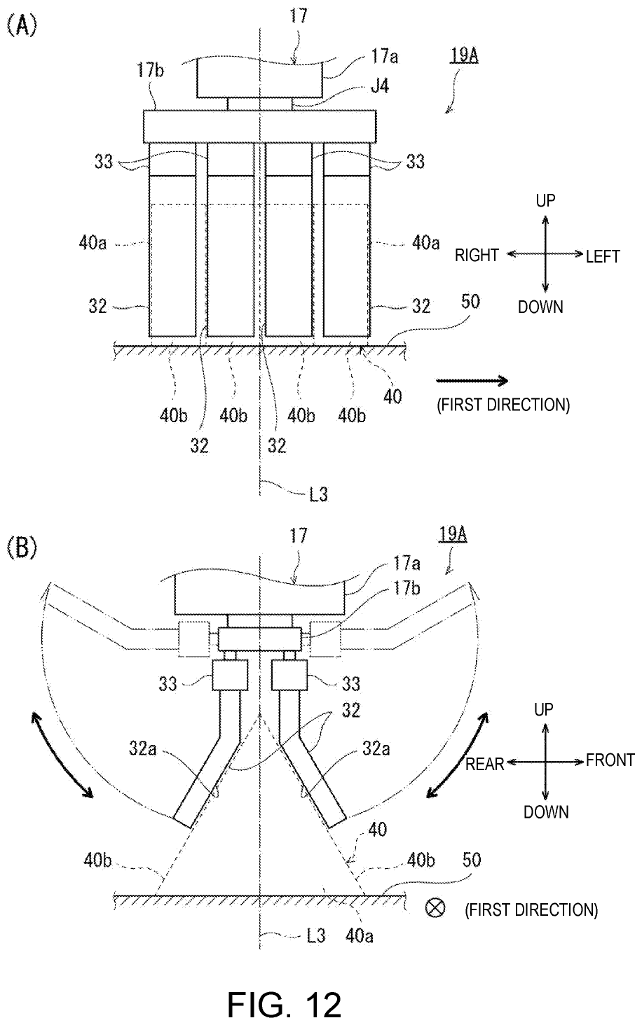

FIGS. 12(A) and 12(B) are a front view and a side view illustrating a structure of the left hand part 19A (second holding part) of another embodiment. As illustrated in FIG. 12(B), the actuator members 33 drive the four pairs of holding members 32 so that the mutual angle of each pair of holding members 32 (contact surfaces 32a) becomes either a first angle or a second angle.

The first angle is a given mutual angle at which each pair of holding members 32 (contact surfaces 32a) can hold each food 40 by pinching the food 40 from both sides. The first angle is an angle corresponding to the inclinations of the both sides (second surface parts 40b) of the food 40, and is about 60 degrees here (see FIG. 12(B)). Alternatively, the food 40 may be held by slightly reducing the mutual angle of each pair of holding members 32 from 60 degrees, or the food 40 may be held by slightly reducing the mutual distance of each pair of holding members 32 from the space corresponding to the inclinations of the second surface parts 40b of the food 40.

The second angle is a given mutual angle, which is 180 degrees or more, at which each pair of holding members 32 (contact surfaces 32a) can release each food 40. Here, the second angle is 180 degrees (see FIG. 12(B)). Thus, it is easy to check a state of the food 40 visually or by a sensor, for example, before the holding operation of the food 40 by the left hand part 19A.

As described above, in this embodiment, since the opening angle of the left hand part 19A only has two values (60 degrees and 180 degrees), a complicated control is not required.

Meanwhile, after accommodating the four pieces of food held by the left hand part 19A into the tray 41, the left hand part 19 must be controlled to cancel the holding operation of the four pieces of food 40 and then immediately evacuate from the tray 41. Each actuator member 33 of the left hand part 19 drives the pair of holding members 32 based on the control command (the release command or hold command) from the control device 14.

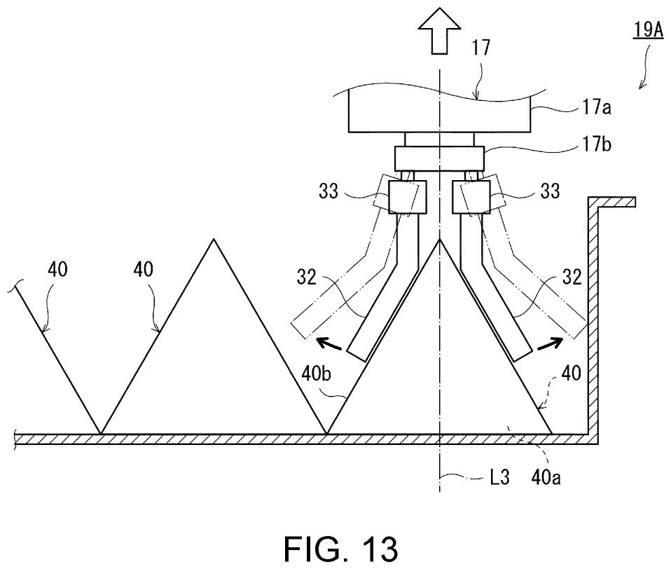

FIG. 13 is a view illustrating the evacuation operation of the left hand part 19A of FIGS. 12(A) and 12(B). As illustrated in FIG. 13, when the left hand part 19A opens 90 degrees or more inside the tray 41, the holding member 32 collides with the inner wall of the tray 41 or the adjacent food 40. Below, the angle (90 degrees) at which the collision occurs may also be referred to as a “third angle.” Since the opening angle of the left hand part 19A is controlled to either 180 degrees or 60 degrees as described above, the collision occurs if the holding operation (180 degrees) of the left hand part 19 is completely canceled inside the tray 41.

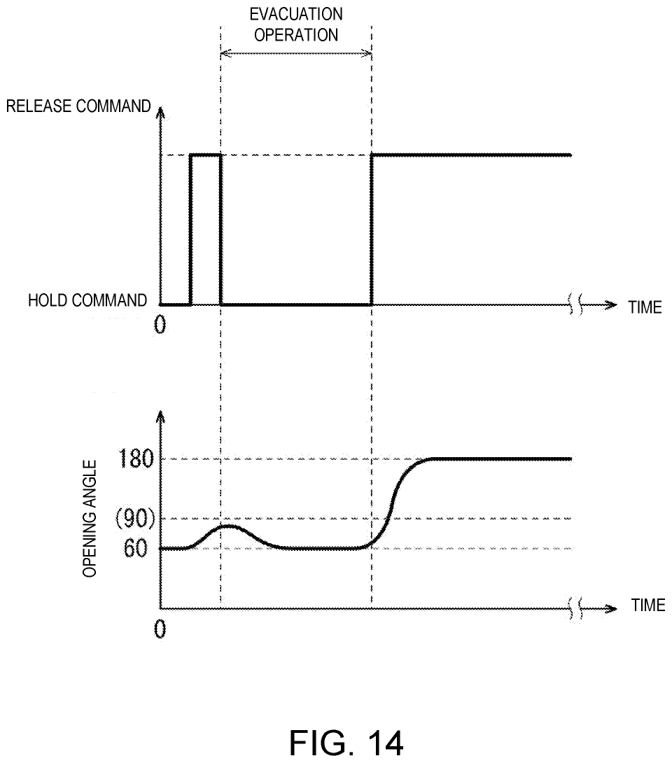

Thus, the control device 14 controls the timing of outputting the control command for the evacuation operation of the left hand part 19A. FIG. 14 is a timing chart illustrating one example of the control command and the angle for the evacuation operation of the left hand part 19A. As illustrated in FIG. 14, the control device 14 first switches the output from the hold command to the release command prior to the evacuation operation of the left hand part 19A. The release command is outputted for a short period of time (e.g., 0.1 seconds). The output is then switched to the hold command, and this command is kept for a given period of time (0.5 seconds). That is, the output is switched from the release command to the hold command at a timing where the mutual angle of each pair of holding members 32 does not exceed the third angle (90 degrees) which is larger than the first angle (60 degrees) and smaller than the second angle (180 degrees). Here, the angle of the holding members 32 is increased (e.g., about 60 degrees plus 10 degrees) only for the short period of time to cancel the holding operation. The angle of the holding members 32 is again decreased while the hold command is maintained, and is then returned to 60 degrees. In the meantime, the control device 14 controls the operation of the left arm 13 to perform the evacuation operation of the left hand part 19A (evacuation command) After the left hand part 19A moves above the height of the tray 41, the control device 14 again outputs the release signal to cancel the holding operation completely (180 degrees). Thus, the evacuation operation of the left hand part 19A is finished.

Thus, when evacuating the left hand part 19A out of the tray 41, the control device 14 can control the opening angle of the left hand part 19A to be smaller than the third angle (90 degrees), by controlling the output timing of the control command to the actuator members 33. Thus, during the evacuation operation of the left hand part 19A, it can be avoided that the holding member 32 collides with the inner wall of the tray 41 or the adjacent food 40. Note that, although the first angle is set as about 60 degrees, it is not limited to this angle, as long as it is a given angle at which the food 40 can be held. Although the second angle is set as 180 degrees, it is not limited to this angle, as long as it is a given angle of 180 degrees or more at which the food 40 can be released. Moreover, although the third angle is set as 90 degrees, it is not limited to this angle, as long as it is a given angle larger than the first angle and smaller than the second angle.

### Second Embodiment

Next, a second embodiment is described. The fundamental structure of a holding device 10 for the food 40 in this embodiment is the same as that of the first embodiment. Below, the description of the structure which is common to the first embodiment is omitted, and only different structure is described.

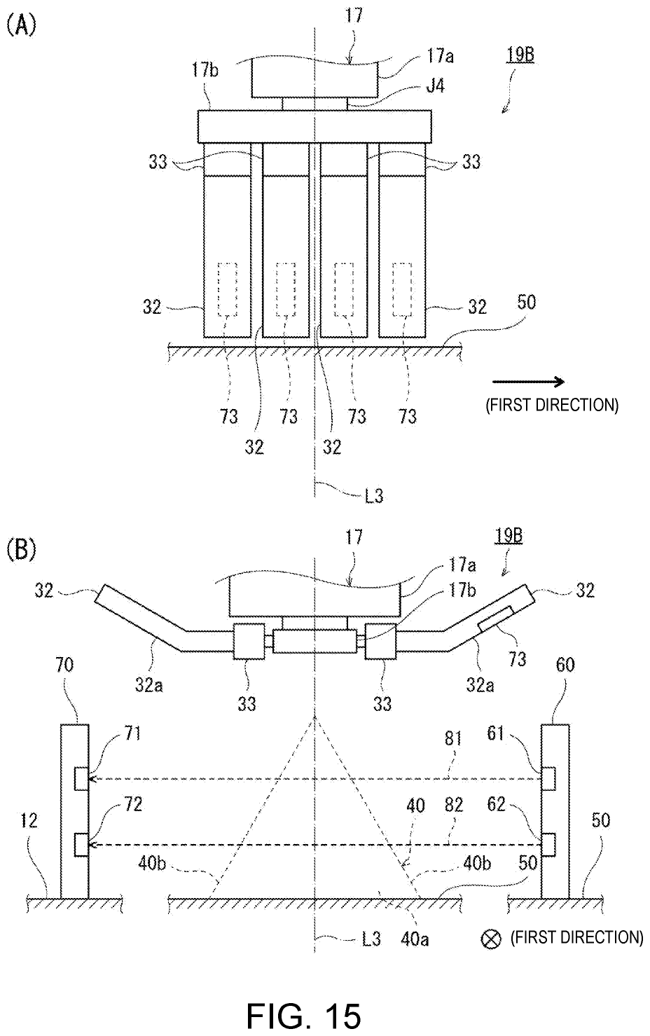

FIGS. 15(A) and 15(B) are views illustrating a structure of a left hand part 19B (second holding part) of the robot 11 according to the second embodiment of the present disclosure. FIGS. 15(A) and 15(B) are a front view and a side view illustrating the structure of the left hand part 19B. The holding device 10 for the food 40 in this embodiment is provided with a function to detect that all of the plurality of foods 40 fed to the given positions is in the second posture. In this embodiment, the left hand part 19B is constructed to be holdable of each food 40 independently. That is, each of the plurality of pairs of holding members 32 is constructed to be drivable by the actuator member 33 independently. Therefore, four pieces of food 40 corresponding to the number of the four holding members 32 driven in the left hand part 19B are fed to the given positions, and the second posture of each food 40 is then detected. As illustrated in FIG. 15(B), the robot 11 in this embodiment differs from that in the first embodiment (see FIGS. 5 and 12) in that it has a transmission-type photoelectric sensor (a light source unit 60 and a photoreceiving unit 70). In this embodiment, the light source unit 60 is installed on the workbench 50 for the robot 11. The light source unit 60 is configured to emit parallel light (broken-line arrows in this figure) in a direction which intersects with (in this figure, a direction perpendicular to) a given direction (a first direction in this figure) to irradiate the four pieces of food 40 fed on the workbench 50 disposed at the given positions. Below, the term “parallel light” means light which goes straight in one direction, without diffusing or converging. The light source unit 60 includes four first light sources 61 each configured to emit a first parallel light 81 toward the food 40, and four second light sources 62 each configured to emit a second parallel light 82 toward the food 40. The four first light sources 61 each irradiates the first parallel light 81 to a position corresponding to an upper part of each of the four pieces of food 40 which is in the second posture on the workbench 50. The four second light sources 62 each irradiates the second parallel light 82 to a position corresponding to a lower part of each of the four pieces of food 40 which is in the second posture on the workbench 50.

The photoreceiving unit 70 is disposed so as to oppose to the light source unit 60, and is configured to receive the parallel lights which pass through above the given positions. In this embodiment, the photoreceiving unit 70 is installed on the base 12 of the robot 11. The photoreceiving unit 70 includes four first photoreceiving parts 71 disposed so as to oppose to the four first light sources 61, and four second photoreceiving parts 72 disposed so as to oppose to the four second light sources 62.

Note that, although in this embodiment the light source unit 60 is installed on the workbench 50 for the robot 11 and the photoreceiving unit 70 is installed on the base 12, the arrangement is not limited to such an arrangement, as long as the units are disposed so as to oppose to each other, and the parallel lights 81 and 82 are emitted in the direction which intersects with the given direction, and are irradiated to the plurality of foods 40 fed on the workbench 50. For example, the light source unit 60 may be installed on the base 12, and the photoreceiving unit 70 may be installed on the workbench 50 for the robot 11.

Moreover, the actuator members 33 drive the four pairs of holding members 32 so that the mutual angle of each pair of holding members 32 (contact surfaces 32a) becomes either the first angle or the second angle.

The first angle is the given mutual angle of each pair of holding members 32 (contact surfaces 32a) at which the food 40 can be held by pinching the food 40 from both sides. The first angle is the angle corresponding to the inclinations on both sides (second surface parts 40b) of the food 40, and it is about 60 degrees here. Alternatively, the food 40 may be held by reducing the mutual angle of each pair of holding members 32 to the angle slightly smaller than 60 degrees. Alternatively, the food 40 may be held by reducing the mutual distance of each pair of holding members 32 slightly smaller than the distance corresponding to the inclinations of the second surface parts 40b of the food 40.

The second angle is the given angle at which each food 40 can be released by the mutual angle of each pair of holding members 32 (contact surfaces 32a) becoming 180 degrees or more. Here, the second angle is 180 degrees (see FIG. 15(B)). Thus, since each pair of holding members 32 can be driven so that the mutual angle thereof becomes 180 degrees or more, the determination of the food by the photo sensor becomes easier, for example, without the parallel lights 81 and 82 from the light source unit 60 being interrupted by each pair of holding members 32, by controlling the mutual angle of each pair of holding members 32 to be the second angle before the holding operation of the food.

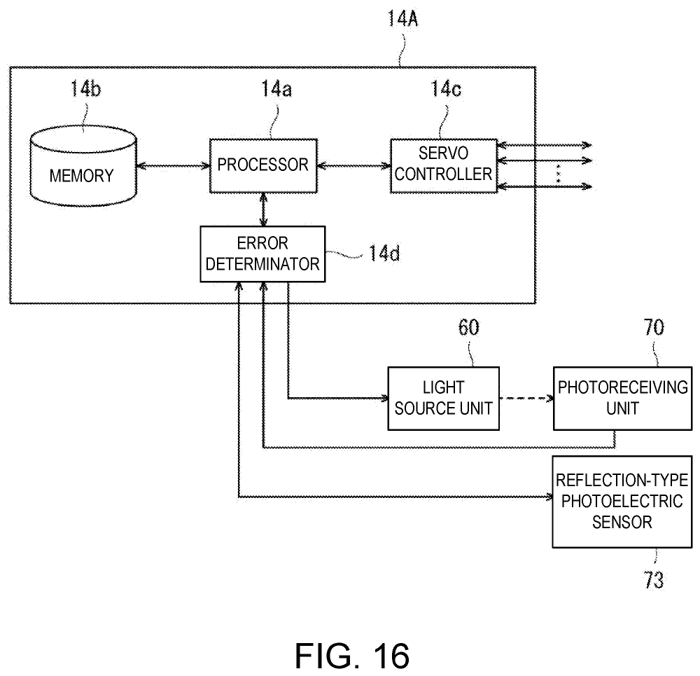

FIG. 16 is a functional block diagram schematically illustrating a configuration of a control device 14A of the robot 11 having the hand part 19B in FIGS. 15(A) and 15(B). As illustrated in FIG. 16, the control device 14A in this embodiment differs from the first embodiment (see FIG. 6) in that it is provided with an error determinator 14d. The error determinator 14d corresponds to a “second posture determining part” and a “second hold determining part” of the present disclosure.

The error determinator 14d determines whether all the plurality of foods fed to the workbench 50 is in the second posture based on the detection results of the parallel lights 81 and 82 by the photoreceiving unit 70. In this embodiment, if the error determinator 14d determines that all the plurality of foods are in the second posture on the workbench 50, the servo controller 14c then controls the operation of the left hand part 19 to hold the plurality of foods in the second posture, while the foods being laterally piled up in the given direction.

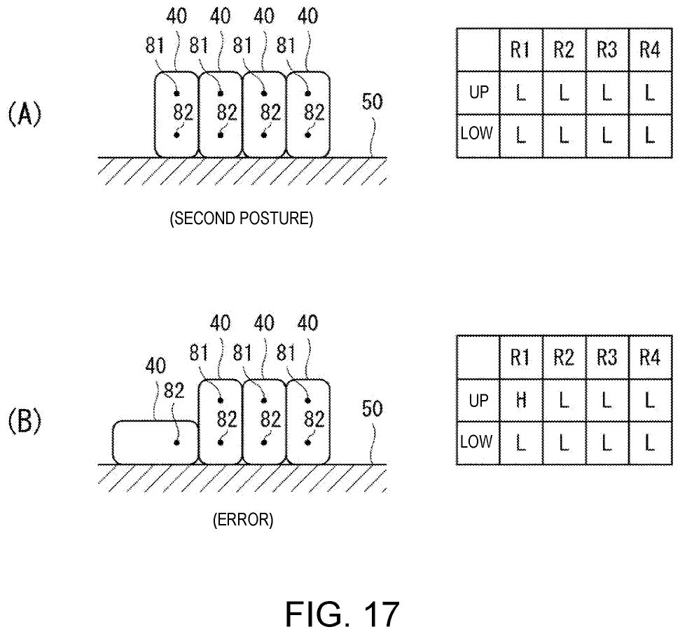

Next, error determination processing executed by the robot in this embodiment is described using FIGS. 17(A) and 17(B). FIG. 17(A) is a schematic diagram illustrating a case where all the four pieces of food 40 maintain the second posture on the workbench 50. The left tables indicate the detection results of the parallel lights 81 and 82 by the photoreceiving unit 70. “L” in the table represents that a photoreceiving quantity is less than a given threshold (Low level). “H” in the table represents that the photoreceiving quantity is greater than the given threshold (High level). Here, the detection results of the upper photoreceiving part 71 and the lower photoreceiving part 72 are indicated for each food 40. All the detection results of the four first photoreceiving parts 71 and the four second photoreceiving parts 72 are Low level. That is, since all the four first parallel lights 81 are interrupted by the upper parts of the four pieces of food 40 in the second posture, none of the four first photoreceiving parts 71 receives the four first parallel lights 81, and since all the four second parallel lights 82 are interrupted by the lower parts of the four pieces of food 40 in the second posture, none of the four second photoreceiving parts 72 receives the four second parallel lights 82. In this case, the error determinator 14d determines that all the four pieces of food 40 are in the second posture at the given positions, and outputs a determination result (the second posture is normal) to the processor 14a. If received the determination result (the second posture is normal) from the error determinator 14d, the processor 14a outputs a control command for the robot 11 to the servo controller 14c so that the four pieces of food 40 in the second posture are held in the laterally piled-up manner in the first direction by the left hand part 19.

FIG. 17(B) is a schematic diagram illustrating a case where one of the four pieces of food 40 does not maintain the second posture on the workbench 50. In this figure, one piece of food 40 at the left end fell down so that the second posture is not maintained (e.g., the food 40 is in the first posture). Only the detection result of one of the four first photoreceiving parts 71 corresponding to the left-end food 40 is High level. When the first parallel light 81 passes through the position corresponding to the upper part of the left-end food 40 and the four first photoreceiving parts 71 receives one of the four first parallel lights 81, the error determinator 14d determines that the food 40 corresponding to the received first parallel light 81 is not in the second posture at the given position, and then outputs a determination result (the second posture is error) to the processor 14a. When received the determination result (the second posture is error) from the error determinator 14d, the processor 14a outputs a control command for the robot 11 to the servo controller 14c so that given error processing is performed. Note that, although in this embodiment the error processing is to move the four pieces of food 40 including the fallen food 40 to another container, it is not limited to this processing. The error processing may be to stop the robot 11.

Therefore, according to this embodiment, since it is provided with the transmission-type photoelectric sensor which is detectable of the parallel lights 81 and 82 irradiated from the light source unit 60 by the photoreceiving unit 70, it can be determined, based on the detection results, whether the four pieces of food 40 are in the second posture at the given positions. Only when all the four pieces of food 40 are detected to be in the second posture at the given positions, the foods 40 are held while being laterally piled up in the given direction, thus, the foods 40 are securely held and accommodated into the tray 41. Therefore, the efficiency of the packing work of the foods is improved, and the accuracy of the work is improved, even within the limited workspace.

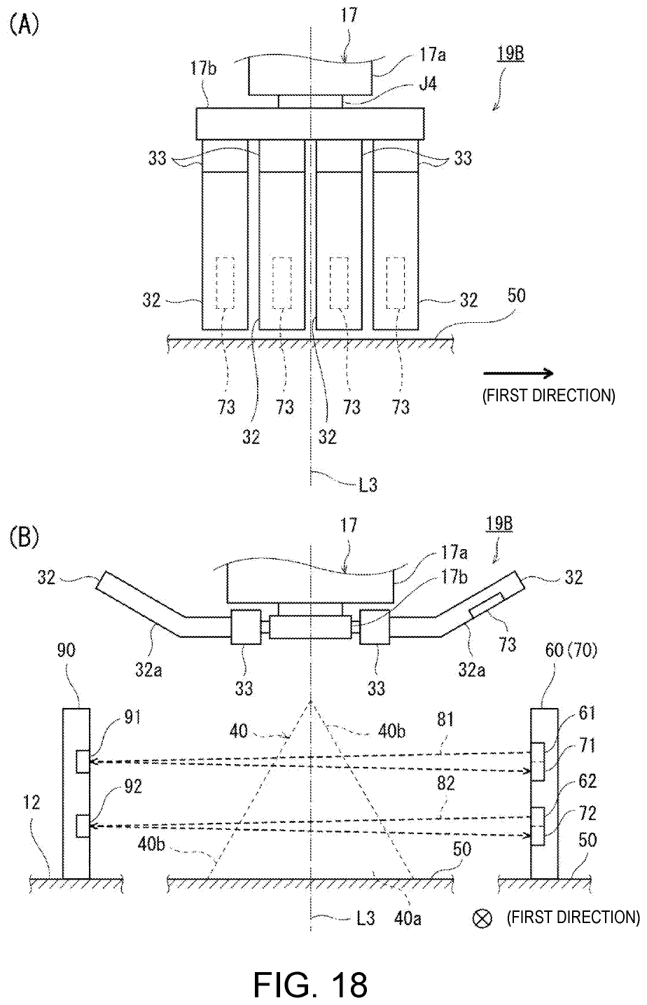

Note that, although in this embodiment the second posture of the food 40 is detected by the transmission-type photoelectric sensor, the second posture may be detected by a reflection-type photoelectric sensor. FIGS. 18(A) and 18(B) are views illustrating a structure according to a first modification of this embodiment. As illustrated in FIGS. 18(A) and 18(B), the structure of the left hand part 19B is similar to that in this embodiment, but this modification differs from this embodiment in that the light source unit 60 and the photoreceiving unit 70 are configured integrally on the workbench 50, and a reflection unit 90 is further provided on the base 12 of the robot 11, in order to reflect the parallel lights 81 and 82. The reflection unit 90 has reflection plates 91 and 92 disposed at an upper part and a lower part. The four first photoreceiving parts 71 are configured to receive reflected lights of the four first parallel lights 81 which pass through the positions corresponding to the upper parts of the four pieces of food 40. The four second photoreceiving parts 72 are configured to receive reflected lights of the four second parallel lights 82 which pass through the positions corresponding to the lower parts of the four pieces of food 40.

Since all the four first parallel lights 81 are interrupted by the upper parts of the four pieces of food 40 in the second posture at the given positions, none of the four first photoreceiving parts 71 receives the reflected lights of the four first parallel lights 81, and since all the four second parallel lights 82 are interrupted by the lower parts of the four pieces of food 40 in the second posture at the given positions, none of the four second photoreceiving parts 72 receives the reflected lights of the four second parallel lights 82. If both the conditions are satisfied, the error determinator 14d determines that all the four pieces of food 40 are in the second posture at the given positions.

On the other hand, if any of the four first parallel lights 81 passes through the position corresponding to the upper part of the food 40 of at least one of the four pieces of food 40, and the four first photoreceiving parts 71 receives the reflected light of at least one of the four parallel lights, the error determinator 14d determines that the food 40 corresponding to the received reflected light is not in the second posture at the given positions (e.g., the food 40 is in the first posture).

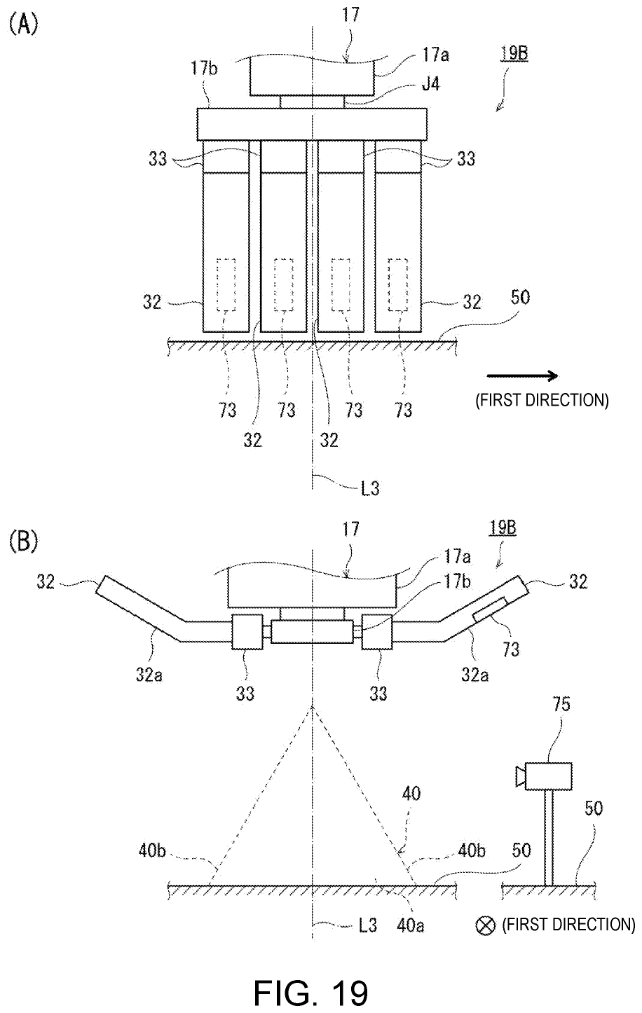

FIGS. 19(A) and 19(B) are views illustrating a structure according to a second modification of this embodiment. As illustrated in FIGS. 19(A) and 19(B), the structure of the left hand part 19B is similar to that in this embodiment, but this modification differs from this embodiment in that it is provided with a vision sensor 75 instead of the photoelectric sensor. Thus, the second posture of the food 40 may be detected based on a detection result of the vision sensor (camera). Other detectors, such as an ultrasonic sensor or a limit switch, may be provided.

Meanwhile, the holding device 10 for the food 40 in this embodiment is also provided with a function to detect that it is in a state where all the plurality of foods are held by the second holding parts. For example, the error determinator 14d determines whether all the four pieces of food 40 are held by the left hand part 19. As illustrated in FIGS. 15(B), 18(B), and 19(B), in each pair of holding members 32, a reflection-type photoelectric sensor 73 is provided to the food-side contact surface 32a of one of the holding members 32. The state whether the four pieces of food 40 are held is detected by the respective four reflection-type photoelectric sensors 73. The error determinator 14d determines whether each of the four pieces of food 40 is held based on detection results (the second hold is normal or the second hold is error) of the four reflection-type photoelectric sensors 73, and then output a determination result to the processor 14a. If received the determination result (the second hold is normal) from the error determinator 14d, the processor 14a outputs a control command for the robot 11 to the servo controller 14c so that the four pieces of food 40 held by the left hand part 19 is accommodated into the tray 41. On the other hand, if the determination result (the second hold is error) is received from the error determinator 14d, the processor 14a outputs a control command for the robot 11 to the servo controller 14c so that given error processing is performed. Note that, although in this embodiment the error processing is the operation in which the packing operation of the food 40 into the tray 41 is stopped, and the remaining food(s) 40 which is held is transferred to another container, it is not limited to this. The error processing may be to stop the robot 11. Thus, the certainty of the work improves.

Moreover, since in this embodiment the four reflection-type photoelectric sensors 73 detect whether it is in the state where the respective four pieces of food 40 are held, it can be determined whether each food is held. Note that the second hold detector may detect the state where each of the four pieces of food 40 is held based on the detection result of other detectors, such as a limit switch.

### Third Embodiment

Next, a third embodiment is described. The fundamental structure of the holding device 10 for the food 40 in this embodiment is similar to that in the first embodiment. Below, the description of the structure which is common to the first embodiment is omitted, and only different structure is described.

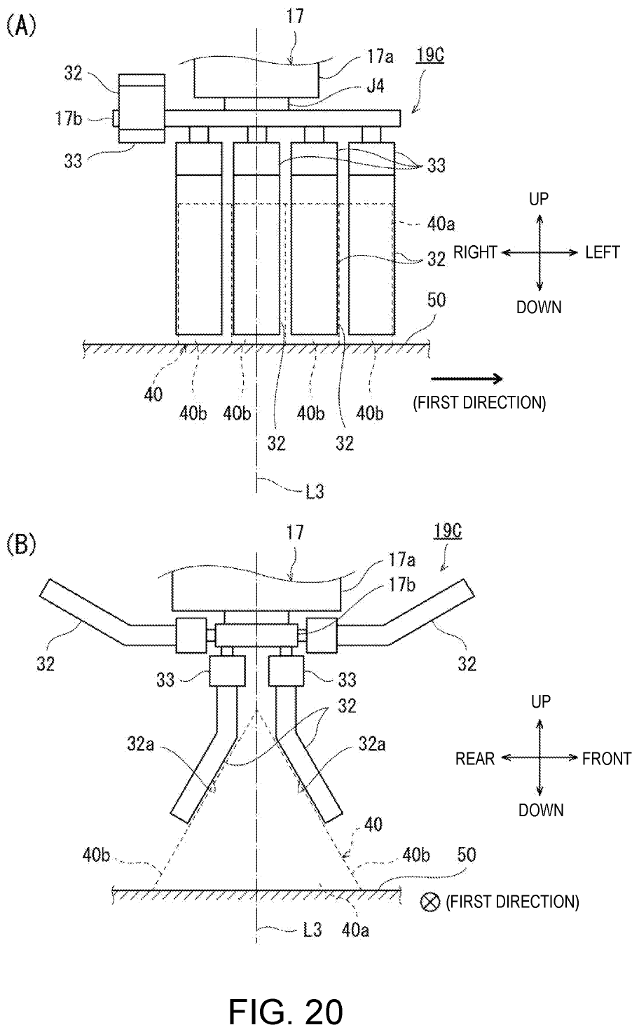

FIGS. 20(A) and 20(B) are a front view and a side view illustrating a structure of a hand part 19C of the holding device for the food according to the third embodiment of the present disclosure. In this embodiment, it differs from the first embodiment (see FIGS. 5 and 12) in that the control device 14 controls the actuator members 33 so that the mutual angle of at least one pair of holding members 32, which is specified beforehand, among the plurality of pairs of holding members 32 becomes the first angle or the second angle, and if any non-specified pair of holding members 32 exists, the control device 14 controls the actuator members 33 so that the mutual angle of the non-specified pair of holding members 32 is fixed to the second angle.

Note that a method of specifying the holding members 32 is arbitrary, and the holding members 32 may be specified by receiving an input by a worker. Moreover, each of five pairs of holding members 32 can be driven independently by the actuator members 33. Therefore, in FIGS. 20(A) and 20(B), the control device 14 is capable of specifying four pairs of holding members 32 from the left beforehand among five pairs of holding members 32, as the holding members 32 to perform the holding operation, and controlling the actuator members 33 to fix the pair of holding members 32 at the right end to the second angle (non-driven state).

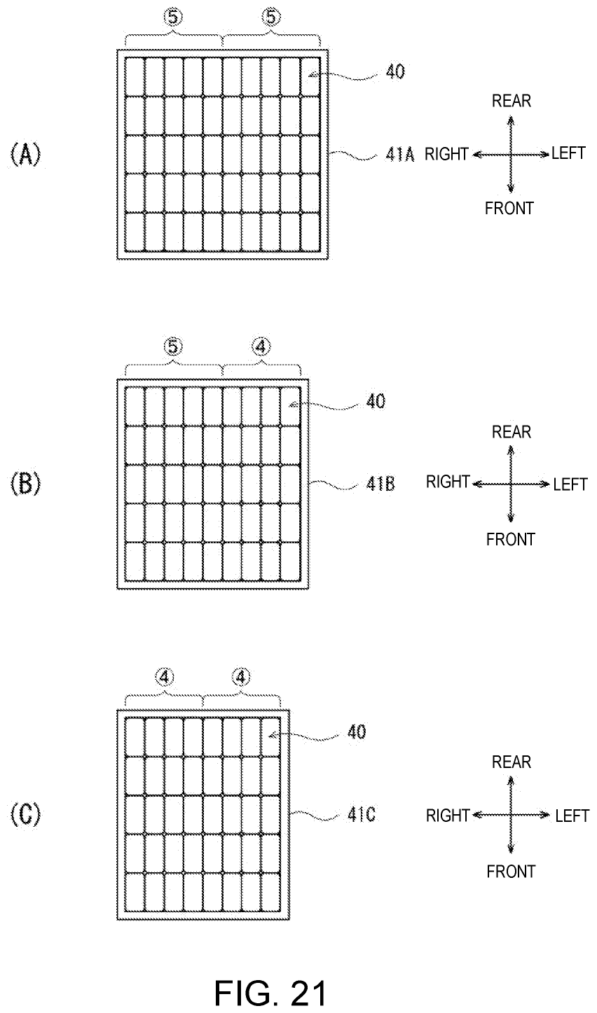

FIGS. 21(A) to 21(C) are views illustrating the tray 41 used for the packing work of the foods by the robot provided with the hand part 19C. A tray 41A in FIG. 21(A) is a container which can accommodate 50 pieces of food 40 (10×5). In this case, by specifying all the five pairs of holding members 32 and repeating the packing operation of the five pieces of food 40 into the tray 41A, the 50 pieces of food (10×5) can be packed in the laterally piled-up manner. A tray 41B in FIG. 21(B) is a container which can accommodate 45 pieces of food 40 (9×5). In this case, by alternately specifying five pairs of holding members 32 and four pairs of holding members 32, and alternately repeating the packing operation of the five pieces of food 40 into the tray 41B and the packing operation of the four pieces of food 40 into the tray 41B, the 45 pieces of food (9×5) can be packed in the laterally piled-up manner. A tray 41C in FIG. 21(C) is a container which can accommodate 40 pieces of food 40 (8×5). In this case, by specifying four pairs among the five pairs of holding members 32, and repeating the packing operation of four pieces of food 40 into the tray 41C, the 50 pieces of foods (8×5) can be packed in the laterally piled-up manner. According to this embodiment, the packing work is flexibly applicable to any trays 41A-41C having different storage capacities.

Moreover, the control device 14 may control the actuator members so that the number of pairs of holding members to drive is reduced according to an empty space inside the tray 41 for the foods 40, and the mutual angle of the remaining pair(s) of holding members becomes the first angle or the second angle, and if any pair of holding members 32 which has been reduced exists, the control device 14 may control the actuator members 33 to fix the mutual angle of the pair(s) of holding members 32 to the second angle.

For example, in the tray 41B of FIG. 21(B), nine pieces can be accommodated per row. In this case, the control device 14 first drives five pairs of holding members 32 to pack five pieces of food 40 into the first row of the tray 41B. At this time, only a space for four pieces of food 40 remains in the first row of the tray 41B. The control device 14 decreases the number of pairs of holding members to drive, and then drives the remaining four pairs of holding members 32 to pack four pieces of food 40 into the empty space of the first row of the tray 41B. Thus, 45 pieces of food (9×5) can be packed in the laterally piled-up manner by alternately repeating the packing operation of five pieces of food 40 into the tray 41B and the packing operation of four pieces of food 40 into the tray 41B according to the empty space per row in the tray 41B. When driving the remaining four pairs of holding members 32 and packing four pieces of food 40 into the empty space of the first row of the tray 41B, the pair of holding members 32 which are not driven may be a pair of holding members 32 far from the inner wall (left wall in FIG. 21(B)) of the tray 41B adjacent to the empty space (right holding member 32 in FIG. 20(A)). Thus, the collision of the non-driving pair of holding members 32 with the inner wall of the tray 41B can be prevented more certainly. Similarly, when packing the foods 40 into the empty space adjacent to the inner wall of the tray 41B, if there are a plurality of non-driving pairs of holding member 32, all the non-driving pairs of the holding members 32 may be the pair of holding member 32 located far from the inner wall of the tray 41B adjacent to the empty space. Moreover, when packing the foods 40 into the empty space adjacent to the inner wall of the tray 41B, if there is a non-driving pair of holding members 32, at least a pair of holding members 32 located nearest to the inner wall of the tray 41B adjacent to the empty space may be driven to hold the foods 40.

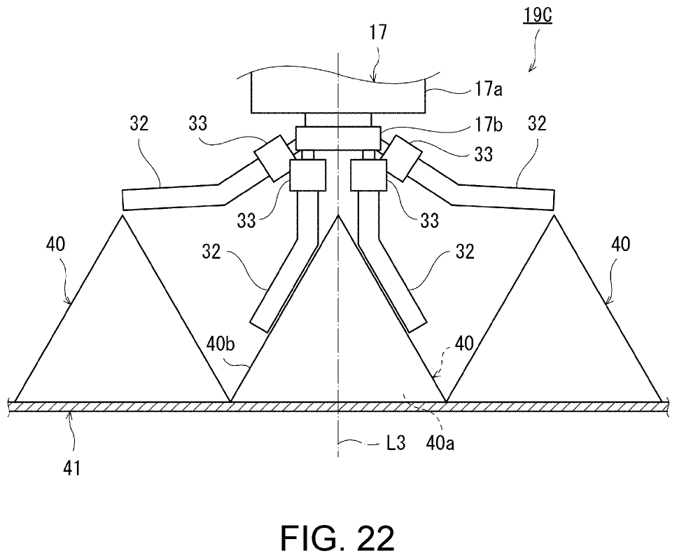

Note that, although in this embodiment the second mutual angle of each pair of holding members 32 in the non-driven state is fixed to 180 degrees (see FIG. 20(B)), it is not limited to this angle if the height at the tip ends of each pair of holding members 32 becomes higher than the height of the food 40 when the pair of holding member 32 are opened. FIG. 22 is a view illustrating a structure according to a modification of the hand part (second holding part) in FIG. 20(B). As illustrated in FIG. 22, the second angle is such a given angle that the height at the tip ends of each pair of holding members 32 becomes slightly higher than the height of the foods 40 when the pair of holding members 32 are opened. Thus, when accommodating the foods 40 into the tray 41 by driving the holding members 32, it can prevent that the remaining holding members 32 in the non-driven state interfere with the other adjacent foods 40 accommodated in the tray 41. Thus, the certainty of the work improves.

Note that in the embodiment the control device 14 controls the operation of the right arm 13 to feed the foods 40 held in the second posture by the right hand part 18 to the position on the sheet 50a placed on the workbench 50 (see FIG. 8). By repeating the above operation, four pieces of food 40 are sequentially fed to the positions on the sheet 50a placed on the workbench 50. In order to stabilize the posture of the food 40 (second posture) on the sheet 50a, a cross-sectional shape of the sheet 50a has the following features.

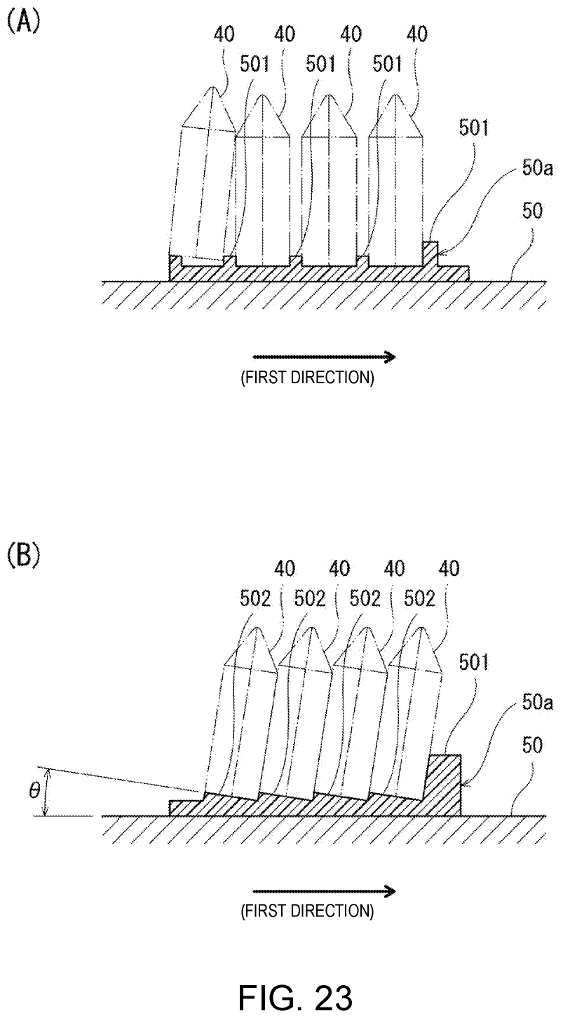

FIG. 23(A) illustrates one example of the cross-sectional view of the sheet 50a in the first direction. As illustrated in FIG. 23(A), the sheet 50a has a plurality of convex parts 501 lined up in the first direction in the cross-sectional view in the first direction. The material of the sheet 50a may be, but not limited to, synthetic resin, such as plastic. In the cross-sectional view, the convex parts 501 are lined up in the first direction so that the respective four pieces of food 40 lined up in the first direction are supported in the second posture. In this embodiment, five convex parts 501 are provided. Four pieces of food 40 are accommodated in the spaces between the five convex parts 501. The forwardmost food 40 among the four pieces of food 40 tends to be added with the largest load in the first direction. For this reason, the convex part 501 for supporting the forwardmost food 40 is made taller than other convex parts 501. By having the plurality of convex parts 501, the posture of each food 40 (second posture) on the sheet 50a can be stabilized. Therefore, it is easier to hold the four pieces of food 40 in the laterally piled-up manner in the first direction by the left hand part 19A.

FIG. 23(B) illustrates a cross-sectional view of another example of the sheet 50a. As illustrated in FIG. 23(B), the sheet 50a has a plurality of steps 502 lined up in the first direction in the cross-sectional view in the first direction. The steps 502 are provided so as to incline in the first direction the four pieces of food 40 lined up in the first direction, while supporting the respective four pieces of food 40 in the second posture. In this embodiment, four steps 502 are provided. An inclination angle θ is, for example, 7 degrees with respect to the first direction. Although four pieces of food 40 are disposed on the respective four steps 502, the forwardmost food 40 is added with a load in the first direction because each step 502 is inclined. For this reason, the convex part 501 for supporting the forwardmost food 40 is provided. By having the plurality of steps 502, the posture of each food 40 (second posture) on the sheet 50a can be stabilized. Therefore, it is easier to hold the four pieces of food 40 in the laterally piled-up manner in the first direction by the left hand part 19A.

Moreover, although in the embodiment, the right hand part 18 is structured to suck and hold the food 40 by the suction heads 22, other structure may be possible as long as it can hold the food 40 in the first posture. For example, the right hand part 18 may be structured to hold food 40 by a chuck device.

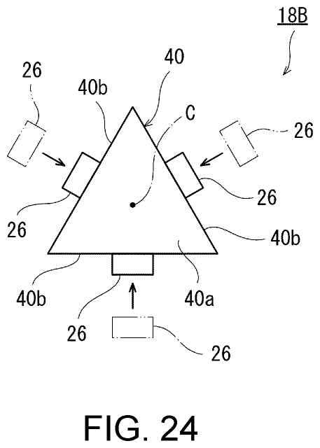

FIG. 24 is a plan view illustrating another structure of the right hand part 18B. As illustrated in FIG. 24, a right hand part 18B includes a chuck body (not illustrated), and three chuck members 26 disposed on the chuck body so as to be separated from each other and hold the food 40. The right hand part 18B is constructed to hold the food 40 by moving the chuck members 26 radially inwardly from outward with respect to a center axis C of the food 40 (arrow directions in the figure) disposed at the given position.

Note that although in the embodiment, the left hand parts 19 and 19A is constructed to have the four pairs of holding members 32 lined up in the first direction, and the four actuator members 33 capable of independently driving the respective four pairs of holding members 32, to hold the respective four pieces of food 40, the left hand parts 19 and 19A may be constructed to collectively hold the four pieces of food 40 by a pair of holding members. In this case, the pair of holding members may be constructed to cover the side surfaces of the four pieces of food 40 laterally piled up in the first direction. Further, as illustrated in FIG. 12(B), the pair of holding members may be driven to be either the angle at which the pair of holding members hold the foods 40 or the angle at which the pair of holding members release the food 40. Moreover, the holding member(s) may have a plurality of suction ports, and may be constructed to hold the plurality of foods 40 by a suction force. For example, in the case illustrated in FIG. 21(B), the control device 14 first holds five pieces of food 40 by the suction ports provided to the positions corresponding to the five pieces of food 40, and packs the five pieces of food 40 into the first row of the tray 41(B). At this time, only a space for four pieces of food 40 remains in the first row of the tray 41(B). Next, the control device 14 holds four pieces of food by the suction ports provided to the positions corresponding to the four pieces of food 40, and packs the four pieces of food 40 into the empty space in the first row of the tray 41(B). When holding the four pieces of food by the suction ports, the control device 14 may drive an electromagnetic valve to turn OFF the suction state of the suction port which does not hold the food 40. Moreover, when packing the foods 40 into the empty space adjacent to the inner wall of the tray 41B, all the suction ports which do not hold the foods 40 may be the suction ports far from the inner wall of the tray 41B adjacent to the empty space. The holding member may have a plurality of suction ports in order to suck one second surface part 40b. Thus, the suction force applied to the food 40 through the suction ports can be distributed, which prevents a local deformation of the food 40. This is especially effective when the food 40 is a rice ball wrapped around with a sheet of dried seaweed. This is because the dried seaweed is easily torn when deformed in its thickness direction. Also when holding the food 40 by pinching the food 40 with the pair of holding members, the local deformation of the food 40 can be prevented by forming the portion of the holding member which contacts the food 40 into a surface or a plurality of points. Note that, although in the embodiment, when the food 40 is the rice ball (40), the left and right holding members 32 are structured not to contact the film in the upper part of the rice ball (40), the left and right holding members 32 may be constructed to hold the food by pinching a wrapping material, such as the film in the upper part of the rice ball (40). Although in the above description the case where the food is packed into the tray is illustrated, the food may be placed in the tray.

Note that, although in the embodiment, the left hand part 19 is structured to hold the four or five pieces of food 40, the number of holding members 32 lined up in the first direction may be changed, or the number of holding members 32 specified to be driven may be changed, to hold two pieces or three pieces of food 40, or hold five or more pieces of food 40.

Note that, although in the embodiment, the food 40 is the triangular pillar-shaped object (triangular rice ball), it is not limited to this shape, and may be a circular cylindrical object (round rice ball), or may be a flat shape.

Note that, although in the embodiment, the holding device 10 for the food 40 is used for the packing work of the plurality of foods 40 into the tray 41, it may be applied to other works which require holding of a plurality of foods 40. Note that, as illustrated in FIG. 8, in the above embodiment, the control device 14 is configured to sequentially feed the plurality of foods 40 held in the second posture on the sheet 50a disposed at the given position of the workbench 50, the given position may include a plurality of positions, without being limited to a single position. For example, two sheets 50a may be disposed at given two positions on the workbench 50. The control device 14 may be configured to sequentially feed the plurality of foods 40 held in the second posture onto each sheet 50a, and accommodate the plurality of foods 40 disposed on each sheet 50a into the tray 41.

It is apparent for a person skilled in the art that many improvements and other embodiments of the present disclosure are possible from the above description. Therefore, the above description is to be interpreted only as illustration, and it is provided in order to teach a person skilled in the art the best mode which implements the present disclosure. The details of the structures and/or the functions may substantially be changed, without departing from the spirit of the present disclosure.

### INDUSTRIAL APPLICABILITY

The present disclosure is useful as the holding device for food when packing the food into the tray.

### DESCRIPTION OF REFERENCE CHARACTERS

10 Holding Device
11 Robot
13 Right Arm (Food Feeding Part)
13 Left Arm (Food Accommodating Part)
14 Control Device
14d Error Determinator
17 Wrist Part
18 Right Hand Part (First Holding Part)
19 Left Hand Part (Second Holding Part)
20 Base Part
21 Tip-End Part
22 Suction Head
25 Actuator
26 Chuck Member
32 Holding Member
33 Actuator Member
40 Food
41, 41A 41B, 41C Tray
50 Workbench
51 First Belt Conveyor
52 Second Belt Conveyor
60 Light Source Unit
61 First Light Source
62 Second Light Source
70 Photoreceiving Unit
71 First Photoreceiving Part
72 Second Photoreceiving Part
73, 74 Reflection-Type Photoelectric Sensor
75 Camera

1. A holding device for food, comprising:
a first holding part configured to hold the food in a first posture where a given first surface of the food is oriented horizontally, and to be changeable of the posture of the food from the first posture into a second posture where a second surface different from the first surface of the food is oriented horizontally;
a food feeding part configured to sequentially feed the food held in the second posture by the first holding part to a given position;
a second holding part configured to hold a plurality of foods fed to the given positions in the second posture, the foods being held so as to be laterally piled up in a given direction;
a food accommodating part configured to accommodate the plurality of foods held by the second holding part into a given container;
a second posture detecting part configured to detect that all the plurality of foods fed to the given positions are in the second posture; and
a control part configured to control operation of the second holding part to hold the plurality of foods in the second posture so that the foods are piled up in the given direction, when the second posture detecting part detects that all the plurality of foods are in the second posture at the given positions.

2. The holding device of claim 1, wherein the second posture detecting part further includes:
a light source unit configured to emit a plurality of parallel lights in a direction intersecting with the given direction, the plurality of parallel lights being irradiated at positions corresponding to the respective foods in the second posture at the given positions;
a photoreceiving unit configured to receive the parallel lights irradiated by the light source unit; and
a second posture determining part configured to determine whether the plurality of foods are in the second posture based on a detection result of the parallel lights by the photoreceiving unit.

3. The holding device of claim 2, wherein the light source unit includes:
a plurality of first light sources configured to emit a plurality of first parallel lights in the direction perpendicular to the given direction, the plurality of first parallel lights being irradiated at positions corresponding to upper parts of the plurality of foods in the second posture at the given positions; and
a plurality of second light sources configured to emit a plurality of second parallel lights in the direction perpendicular to the given direction, the plurality of second parallel lights being irradiated at positions corresponding to lower parts of the plurality of foods in the second posture at the given positions,
wherein the photoreceiving unit further includes:
a plurality of first photoreceiving parts configured to receive the plurality of first parallel lights passing through the positions corresponding to the upper parts of the plurality of foods; and
a plurality of second photoreceiving parts configured to receive the plurality of second parallel lights passing through the positions corresponding to the lower parts of the plurality of foods,
wherein the second posture determining part determines that all the plurality of foods are in the second posture at the given positions, when none of the plurality of first photoreceiving parts receives the plurality of first parallel lights by all the plurality of first parallel lights being interrupted by the upper parts of the plurality of foods in the second posture at the given positions, and none of the plurality of second photoreceiving parts receives the plurality of second parallel lights by all the plurality of second parallel lights being interrupted by the lower parts of the plurality of foods in the second posture at the given positions, and
wherein, when at least one of the plurality of first parallel lights passes through the position corresponding to the upper part of the food, and at least one of the plurality of first photoreceiving parts receives the first parallel light, the second posture determining part determines that the food corresponding to the received first parallel light is not in the second posture at the given position.

4. The holding device of claim 1, further comprising a second hold detector configured to detect that all the plurality of foods are held by the second holding part,
wherein, when the second hold detector detects that all the plurality of foods are held, the control part controls the operation of the food accommodating part to accommodate the plurality of foods held by the second holding part into the given container.

5. The holding device of claim 4, wherein the second hold detector further includes:
a plurality of reflection-type photoelectric sensors configured to detect that each of the plurality of foods is held; and
a second hold determining part configured to determine whether the foods are held based on detection results of the respective reflection-type photoelectric sensors.

6. The holding device of claim 1, wherein the second holding part further includes:
a plurality of pairs of holding members configured to hold the respective foods laterally piled up in the second posture at the given positions; and
actuator members configured to drive the respective pairs of holding members so that a mutual angle of each of the pairs of holding members becomes one of a first angle at which the pair of holding members hold the food and a second angle at which the pair of holding members release the food,
wherein the first angle is a given angle at which the pair of holding members pinch the food from both sides, and
wherein the second angle is a given angle at which a height at tip ends of the pair of holding members becomes higher than a height of the food, when the pair of holding members open.

7. The holding device of claim 1, wherein the second holding part is configured to independently hold each of the plurality of the food.

8. A holding device for food, comprising:
a first holding part configured to hold the food in a first posture where a given first surface of the food is oriented horizontally, and change the posture of the food from the first posture into a second posture where a second surface different from the first surface of the food is oriented horizontally;
a food feeding part configured to sequentially feed the food held in the second posture by the first holding part to a given position;
a second holding part configured to hold a plurality of foods fed to the given positions in the second posture, the food being held so as to be laterally piled up in a given direction; and
a food accommodating part configured to accommodate the plurality of foods held by the second holding part into a given container,
wherein the second holding part includes:
a plurality of pairs of holding members configured to hold the respective foods laterally piled up in the second posture at the given positions; and
actuator members configured to independently drive the respective pairs of holding members so that a mutual angle of each of the pairs of holding members becomes one of a first angle at which the pair of holding members hold the food and a second angle at which the pair of holding members release the food,
wherein the first angle is a given angle at which the pair of holding members pinch the food from both sides, and
wherein the second angle is a given angle at which a height at tip ends of the pair of holding members becomes higher than a height of the food, when the pair of holding members open.

9. The holding device of claim 8, further comprising a control part configured to control the actuator members so that the mutual angle of a prespecified number of the pairs of holding members among the plurality of pairs of holding members becomes one of the first angle and the second angle, and control the actuator members so that, when any non-specified pair of holding members exists, the mutual angle of the non-specified pair of holding members is fixed to the second angle,
wherein the control part controls the food accommodating part to accommodate the foods held by the prespecified pairs of holding members into the given container.

10. The holding device of claim 8, further comprising a control part configured to control the actuator members so that the number of pairs of holding members to drive is reduced according to an empty space for the food in the given container and the mutual angle of the remaining pair of holding members becomes one of the first angle and the second angle, and when the reduced pair of holding members exists, control the actuator members so that the mutual angle of the reduced pair of holding members is fixed to the second angle,
wherein the control part controls the food accommodating part to accommodate the food held by the remaining pair of holding members into the given container.

11. The holding device of claim 8, wherein the holding device is comprised of a robot including:
a first arm having the first holding part at a tip end thereof; and
a second arm having the second holding part at a tip end thereof.

12. The holding device of claim 2, further comprising a second hold detector configured to detect that all the plurality of foods are held by the second holding per,
wherein, when the second hold detector detects that all the plurality of foods are held, the control part controls the operation of the food accommodating part to accommodate the plurality of foods held by the second holding part into the given container.

13. The holding device of claim 3, further comprising a second hold detector configured to detect that all the plurality of foods are held by the second holding per,
wherein, when the second hold detector detects that all the plurality of foods are held, the control part controls the operation of the food accommodating part to accommodate the plurality of foods held by the second holding part into the given container.

14. The holding device of claim 1, wherein the holding device is comprised of a robot including:
a first arm having the first holding part at a tip end thereof; and
a second arm having the second holding part at a tip end thereof.
